(19) United States
(12) Patent Application Publication
(10) Pub. No.: US 2007/0070975 A1
(43) Pub. Date: Mar. 29, 2007

(54) Storage system and storage device

(76) Inventors: Toshio Otani, Kawasaki (JP); Daiki Nakatsuka, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/282,568

(22) Filed: Nov. 21, 2005

(30) Foreign Application Priority Data
Sep. 26, 2005 (JP) 2005-277615

(51) Int. Cl. H04L 12/28

(52) U.S. Cl. 370/351

(57) ABSTRACT

A storage system includes a host having an iSCSI initiator function, a storage having an iSCSI target function and plural storage ports and communicable with the host through an IP network, and a management server communicable with the storage. The management server includes a load information collecting unit for collecting load information on load for each of the storage ports, a network topology information collecting unit for collecting network topology information on the physical topology or on the logical topology of the storage system, and a port selection unit for selecting a failover port when a communication error occurs on one port of the storage ports which is in use to communicate with the host.

### CROSS-REFERENCE TO RELATED APPLICATIONS

This application claims the benefit of Japanese Patent Application 2005-277615 filed on Sep. 26, 2005, the disclosure of which is incorporated herein by reference.

### BACKGROUND OF THE INVENTION

1. Field of the Invention

The present invention relates to a storage system and a storage device, particularly to a storage system and storage device improved in reliability and availability by improving reliability on communications between a host or hosts and a storage system or systems.

2. Description of the Related Art

SAN (Storage Area Network) is a network for providing linkage between storages and between the storages and a host or hosts. In most cases, a conventional SAN has served as a network dedicated to a fiber channel scheme, and IP-SAN developed later is a network using a general-purpose IP (Internet Protocol) scheme. As a general protocol group for communicating with I/O (Input/Output) devices such as a storage device, there has been used Small Computer System Interface (SCSI).

Based on the IP-SAN and the SCSI schemes, an iSCSI (Internet Small Computer Systems Interface) scheme has been established. In iSCSI communications, iSCSI commands and data related thereto are encapsulated and transferred as IP packets via IP networks. At the iSCSI layer upper than the IP layer, an iSCSI command interface is provided in compliance with SCSI command interface.

In iSCSI protocols, a single iSCSI session comprises at least one TCP connection. This session is equivalent to I_T Nexus in SCSI protocols. Therefore, if a single iSCSI session comprises more than one TCP connections, improvement in reliability for communications between a host as an initiator and a storage device as a target can be achieved.

IN a conventional storage system, a first controller monitors a second controller, and if a failure occurs on the second controller, the first controller takes over the IP address of the second controller from the second controller so as to provide a process for an I/O request from the server, for example, as disclosed in JP-A-2003-203019.

In order to establish a single iSCSI session constituted by more than one connection, it is required to provide a setting for every host such that a TCP connection is established for each IP address so as to build redundant paths. However, IP-SAN has been rapidly developed in a larger scale and the number of storage ports significantly increases as the number of hosts connecting thereto increases.

In order to improve reliability in communication between a host and a storage system based on the iSCSI protocol, as disclosed in Document 1, it is required to establish a single iSCSI session constituted by more than one TCP connection, each of which is established for each IP address, whereby to build redundant paths. However, IP-SAN has been rapidly developed in a larger scale and the number of storage ports significantly increases as the number of hosts connecting thereto increases. This causes significant increase in man-hours for operations and managements for the setting in IP-SAN in a larger scale. Document 1: Satran, et al., RFC 3720 “Internet Small Computer Systems Interface (iSCSI)” [online]. The Internet Engineering Task Force (IETF), Aug. 2004. [Retrieved on Aug. 23, 2003]. Retrieved from the Internet: <URL: http://www.ietf.org/rfc/rfc3720.txt>

Further, when establishing a single iSCSI session constituted by more than one TCP connection, each of which is established for each of plural IP addresses, in order to build redundant paths, there have been raised other disadvantages as follows:

The iSCSI layer is located upper than the TCP/IP layer, and if congestions occur in the IP network, packets may be actively discarded so as to recover the network traffics. Therefore, congestions occur on the IP network when performing iSCSI communication may cause a temporary halt of I/O (input and output of data) or deterioration in performance of an effective transfer speed, for example.

To counter this problem, the system can employ a topology in which a path switching is executed every time an I/O halt or performance deterioration occurs. However, this may cause flapping when the network frequently becomes congested, resulting in an unstable communication state. In a conventional iSCSI communication, a path switch is carried out after TCP retransmission or TCP connection timed out, so as to avoid the flapping. Then, there has been another problem that it takes more time in order for the path switching if a failure occurs on the IP layer due to a failure on a storage port, etc.

In a conventional storage system as disclosed in JP-A-2003-203019, a first controller takes over commutation from a second controller when the second controller becomes in trouble, so that a path switching operation is accomplished. However this means that a controller other than the second controller in trouble takes over only the communication on the second controller in trouble.

As more storage ports are increasingly used, the problem has become more significant since a controller serving as a replacement of a bad controller cannot always provide an optimum path setting.

Even if it is well configured to select a proper failover port for a faulty port, another problem may be raised that man-hours for operations and managements to provide a definition between each failover port and its corresponding faulty port in use becomes significantly increased.

In addition, it is difficult to properly select a failover port in accordance with current communication conditions since current I/O states of the storage constantly change every second.

### SUMMARY OF THE INVENTION

In the view of the above problems in the prior arts, the present invention provides a storage system and a storage device improved in reliability and availability by improving communications between a host(s) and a storage device(s).

A first aspect of the present invention provides a storage system comprising:

a host having an iSCSI initiator function;

a storage having an iSCSI target function and plural storage ports, the storage communicable with the host through an IP network; and

a management server communicable with the storage. the management server comprises:

a load information collecting unit for collecting load information on load for each of the storage ports;

a network topology information collecting unit for collecting network topology information on physical topology or on logical topology of the storage system; and

a port selection unit for selecting a failover port when a communication error occurs on one port of the storage ports which is in use to communicate with the host, the selection unit inquiring the load information for each of the storage ports and the network topology information on the physical topology or on the logical topology of the storage system, and selecting for the port in use the failover port out of the storage ports except for the port in use based on the load for each of the storage ports and on the physical topology or the logical topology of the storage system, the selection unit allowing the failover port to take over communication conditions of the port in use so that the failover port maintains the communication on the port in use.

A second aspect of the present invention provides a storage device having an iSCSI target function and plural storage ports, and communicable with a host having an iSCSI initiator function. The storage device comprises:

a communication failure detection unit for detecting a communication failure on one port of the storage ports which is in use to communicate with the host;

a port selection unit for selecting a failover port when the communication error occurring on the port in use, the selection unit selecting the failover port out of the storage ports which belong to the same domain as the port in use, the selection unit allowing the failover port to take over IP address information and iSCSI target information of the port in use; and

an iSCSI session retaining unit for retaining the iSCSI session to the host by sending a Gratuitous ARP packet through the failover port.

Other aspect, features and advantages of the present invention will become apparent upon reading the following specification and claims when taken in conjunction with the accompanying drawings.

### BRIEF DESCRIPTION OF THE DRAWINGS

FIG. 1 is a block diagram showing an outline of a storage system according to a first embodiment of the present invention.

FIG. 2 is a block diagram showing a detailed example of a configuration of a host.

FIG. 3 is a block diagram showing a detailed example of a configuration of a storage device.

FIG. 4 is a block diagram showing a detailed example of a configuration of a management server.

FIG. 5 is a block diagram showing a detailed example of a configuration of a communication device.

FIG. 6 shows an example of a table for path definition information retained in the storage device.

FIG. 7 shows an example of a table for load of port information.

FIG. 8 is a flow chart showing a series of processes to select a failover port for a faulty port in use involved in a communication failure by executing port selection program, and to allow the selected failover port to take over communication conditions on the port in use, so that the failover port can take over the communication on the faulty port in use.

FIG. 9 shows an example of a temporary table at the current time of 00:06.

FIG. 10 is a flow chart showing a detailed explanation of a failover port selection process (S4003).

FIG. 11 shows an example of a table for network topology information.

FIG. 12 shows an example of the temporary table in which information on failover ports is added.

FIG. 13 shows an example of the temporary table that has been created through the processes by the port selection program.

FIG. 14 shows an example of a table for path definition information retained in the storage device, after completion of the failover port setting process (S4006).

FIG. 15 is a flow chart explaining a port switching operation performed by the storage device itself.

FIG. 16 shows an example of a table for path definition information on which the IP address and the target name has been reset from the port in use to the failover port.

FIG. 17 shows the temporary table at the current time of 11:12.

FIG. 18 shows an example of the temporary table after executing the port selection process and others.

FIG. 19 shows an example of a table for the error of port information retained in the storage device.

FIG. 20 is a flow chart showing an example of a series of processes by executing port selection program, in which a selected failover port for a port in use involved in deterioration in communication performance takes over communication conditions on the port in use so that the failover port can take over the communications on this port in use.

FIG. 21 shows an example of a temporary table at the current time of 00:06.

FIG. 22 is a flow chart for a detailed explanation of the port selection process.

FIG. 23 shows the temporary table indicating that an optimum failover port has been selected for the port in use.

FIG. 24 shows an example of a table for path definition information indicating that the failover port has been set.

### DETAILED DESCRIPTION OF PREFERRED EMBODIMENT

Hereinafter, detailed descriptions of preferred embodiments according to the present invention will be given, with reference to the attached drawings.

### First Embodiment

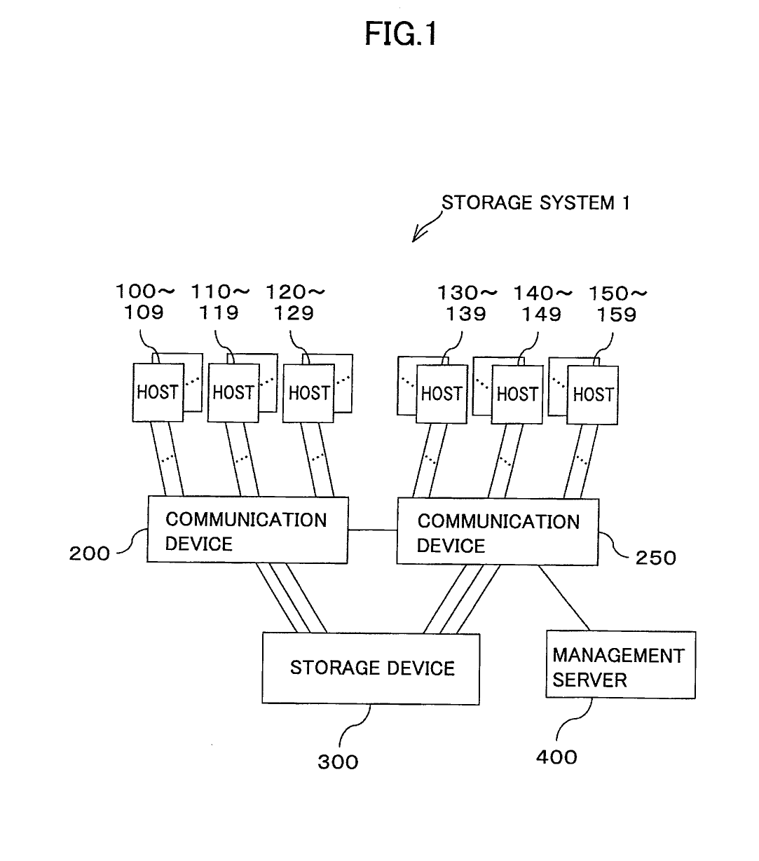

FIG. 1 is a block diagram showing an outline of a storage system 1 according to the first embodiment of the present invention.

This storage system 1 is an IP-SAN system based on iSCSI protocols, and has a plurality of storage ports. When a failure occurs on a port of a target of the system 1, and hinders communication between an initiator of the system 1 and this faulty port, the system 1 selects an appropriate failover port (referred to as “failover port” in the claims of the present invention) for this faulty port in use (referred to as “port in use”) and allows this failover port to take over communication conditions on the faulty port in use, so as to secure a failover path capable of communication between the initiator and the target. Accordingly improvement can be achieved in availability and reliability of the storage system 1.

The storage system 1 comprises hosts 100 to 159, communication devices 200 and 250, a storage device 300 and a management server 400. The hosts 100 to 159 are equivalent to an initiator in iSCSI protocols, and the storage device 300 is equivalent to a target in iSCSI protocols.

Hosts 100 to 109, hosts 110 to 119 and hosts 120 to 129 are respectively connected to the communication device 200. Similarly, hosts 130 to 139, hosts 140 to 149 and hosts 150 to 159 are respectively connected to the communication device 250. The communication devices 220 and 250 are respectively connected to the storage device 300 so that the communication devices 220 and 250 are interconnected to each other. The management server 400 is connected to the communication device 250.

Although the communication devices 200 and 250 are illustrated to be directly connected to the storage device 300 with a plurality of connection lines in the drawing, these connection lines donates that a plurality of logical paths can be provided between the communication devices 200, 250 and the storage device 300. Typically a communicable connection is established between the communication devices 200, 250 and the storage device 300 with a singular or plural IP networks (not shown in the drawing).

As described above, these iSCSI devices (the hosts 100 to 159 and the storage device 300) can send IP packets to each other through the communication device 200 or 250. These devices based on iSCSI protocols communicate with each other by encapsulating iSCSI commands and data related thereto to create iSCSI PDUs, and sending IP packets assembled from the iSCSI PDUs as a payload.

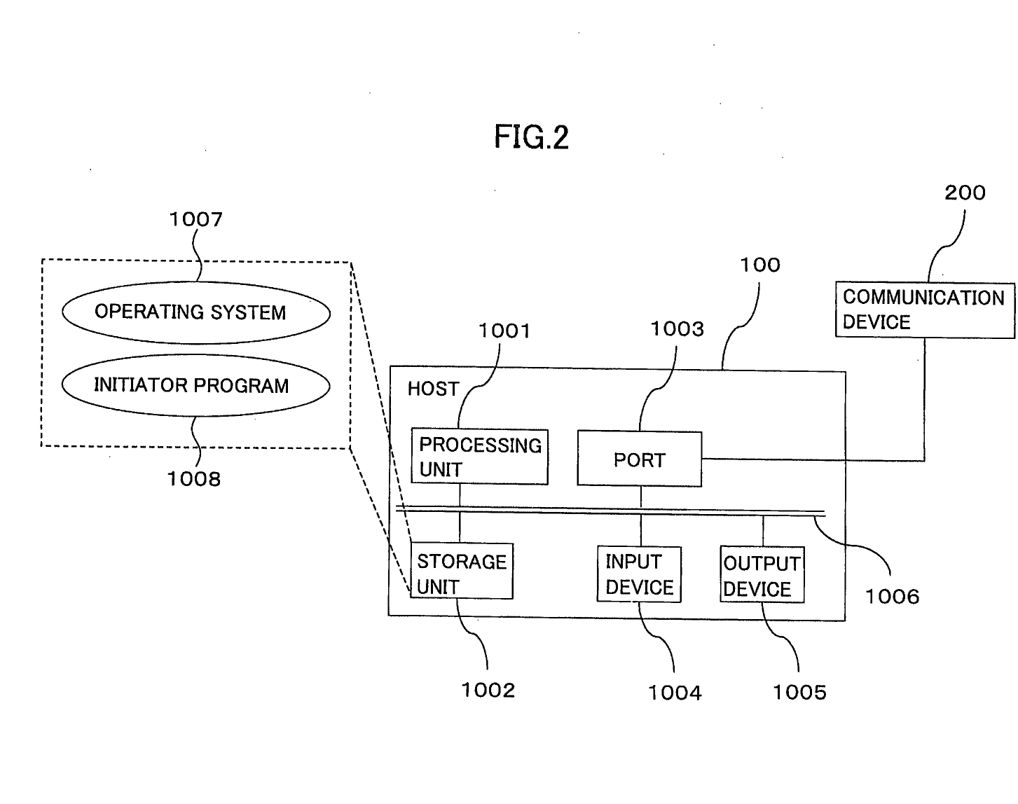

FIG. 2 is a block diagram showing a detailed example of a configuration of the host 100.

The hosts 101 to 159 may have the same configuration as that of the host 100. The host 100 to 159 are each a computer having an iSCSI initiator function.

The host 100 comprises a processing unit 1001 including CPU (not shown in the drawing) for an operation function and a control function, a storage unit 1002 including RAM and functioning as a main storage device and a sub-storage device, a port 1003 functioning as an interface (i.e. IP communication function) to communicate with the communication device 200, an input device 1004 including an input device or devices such as a keyboard and a pointing device and for inputting data and information, an output device 1005 including an output device or devices such as a display device and for outputting data and information, and a bus 1006 for mediating transmission/receipt of data and signals between each component within the host 100.

An operating system (OS; a basic program) 1007 and an initiator program 1008 are loaded onto the storage unit 1002 so that the system 1007 and the program 1008 can be executed by the processing unit 1001.

The operating system 1007 is a program having a memory management function and a task management function, and providing an API (Application Program Interface) function to set an application program executable.

The initiator program 1008 is a program for controlling each component and activating the host 100 to function as an iSCSI initiator. The initiator program 1008 performs a process on iSCSI communications such as transmission/receipt of and assembly/decomposition of packet data while the host 100 performs iSCSI communications.

The host 100 is connected to the communication device 200 via the port 1003, and peforms iSCSI communications with the storage device 300. Similarly, the hosts 101 to 159 perform iSCSI communications with the storage device 300 via the communication device 200 or 250.

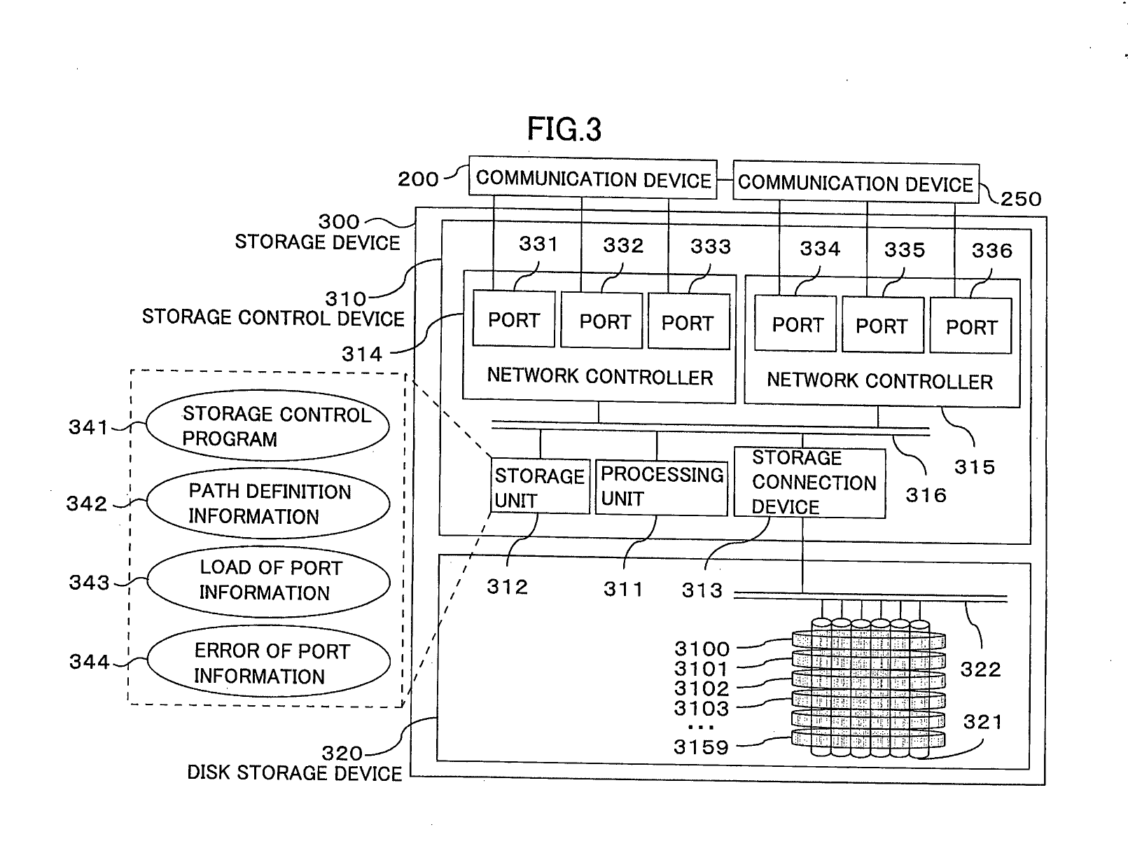

FIG. 3 is a block diagram showing a detailed example of a configuration of the storage device 300.

The storage device 300 comprises a storage control device 310 for controlling the entire storage device 300 and providing a communication function to communicate with external devices, and a disk storage device 320 to provide predetermined data storage areas.

The storage control device 310 comprises a processing unit 311 including CPU for an operation function and a control function, a storage unit 312 including a storage device such as RAM and functioning as a main storage device and a sub-storage device, a network controller 314 equipped with ports 331 to 333 for providing an IP interface function to communicate with the communication device 200, a network controller 315 equipped with ports 334 to 336 for providing an IP interface function to communicate with the communication device 250, a storage connection device 313 connected to the disk storage device 320 so as to mediate data transmission, and a bus 316 for mediating transmission/receipt of data and signals between each component within the storage control device 310.

The disk storage device 320 comprises a physical disk group 321 including physical disk drives and a bus 322 interconnecting these physical disk drives.

Within the disk storage device 320, each storage area for each physical disk drive is managed in a comprehensive manner. Partial storage area into which the entire storage area of a single physical disk drive is divided is put into a combination with other partial storage areas of one or more physical disk drives, so as to create a logical volume as a logical unit (LU). The physical disk group 321 is visible outside the disk storage device 320, as volumes 3100 to 3159 which are logical volumes, and each can be handled as a separate disk drive (logical disk drive).

A storage control program 341 is loaded onto the storage unit 312 so that the storage control program 341 can be executed by the processing unit 311.

A storage control program 341 performs an I/O process based on iSCSI protocols so as to control accesses of external devices to the volumes 3100 to 3159, and allows the storage device 300 to act as an iSCSI target.

The storage unit 312 further rewritably stores path definition information 342 which is a table showing which iSCSI initiator is accessible to which volume, load of port information 343 in which load information on the ports 331 to 336 is recorded, and error of port information 344 in which communication error information on the port 331 to 336 is recorded.

The storage device 300 can provide a setting of plural different paths to the communication device 200 through the ports 331 to 333, and can provide a setting of plural different paths to the communication device 250 through the ports 334 to 336 as well. The storage device 300 has a function for communicating with the communication devices 200 and 250, based on the common communication protocols (IP) through these paths via the ports 331 to 333 and the ports 334 to 336. Accordingly, the storage device 300 and the hosts 100 to 159 can perform iSCSI communications therebetween via the communication device 200 or the communication device 250.

At this time, the storage control program 341 provides a process on iSCSI communications so as to create an environment for the hosts 100 to 159 in which these hosts 100 to 159 can access to the volumes 3100 to 3159.

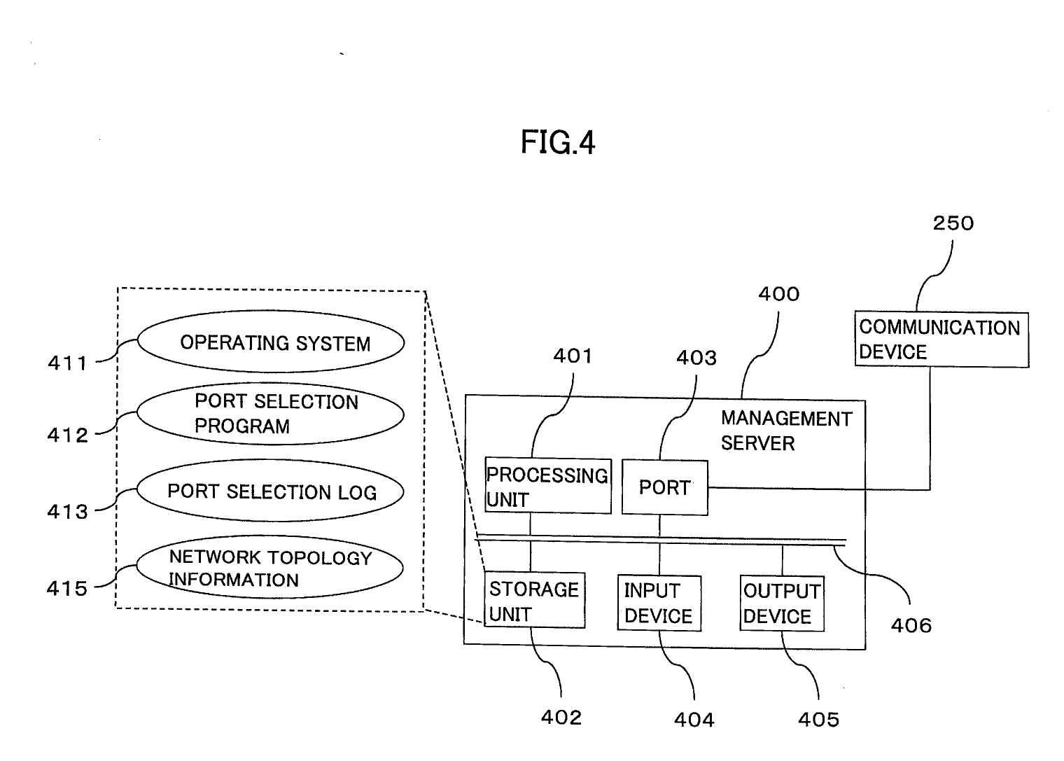

FIG. 4 is a block diagram showing a detailed example of a configuration of a management server 400.

The management server 400 comprises a processing unit 401 including CPU for an operation function and a control function, a storage unit 402 including a storage device such as RAM and functioning as a main storage device and a sub-storage device, a port 403 functioning as an interface to communicate with the communication device 250, an input device 404 including an input device or devices such as a keyboard and a pointing device and inputting data and information, an output device 405 including an output device or devices such as a display device and outputting data and information, and a bus 406 for interconnecting each component within the management server 400 and mediating transmission/receipt of data and signals between each component therewithin.

An operating system (OS; a basic program) 411 and port selection program 412 are loaded onto the storage unit 402 so that the system 411 and the program 412 can be executed by the processing unit 401. The operating system 411 has a memory management function and a task management function and provides an API function. The port selection program 412 has a function to select an adequate failover port from the ports 331 to 336 of the storage device 300, as descried later.

The storage unit 402 rewritably stores port selection log 413 indicating information on failover port selection and network topology information 415 (described later) indicating a network topology.

The management server 400 provides network communication management for the communication device 250 with connection to the communication device 250 via the port 403 through the communication line, and by performing IP-based communication with the communication device 250.

Although the management server 400 is described to be connected to the communication device 250 in the above examples, the server 400 may also be connected to the communication device 200. The communication devices 200, 250 or the storage device 300 may include a configuration and function of the management server 400.

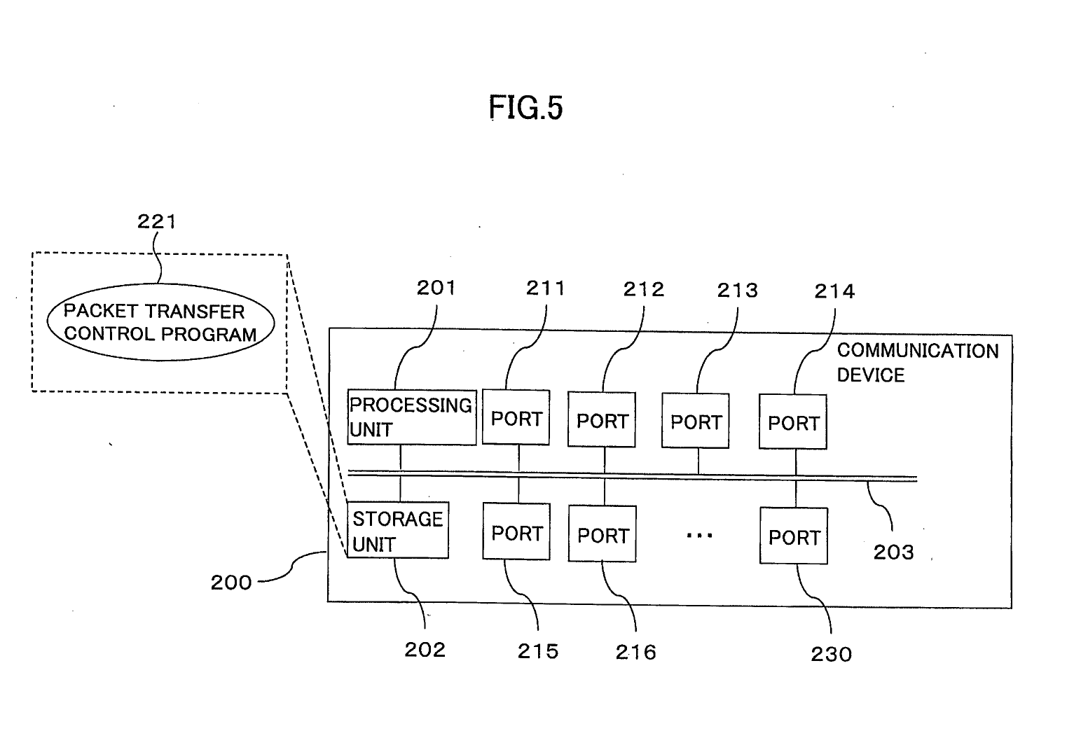

FIG. 5 is a block diagram showing a detailed example of a configuration of the communication device 200.

The communication device 200 comprises a processing unit 201 including CPU for operation function and a control function, a storage unit 202 including a storage device such as RAM and functioning as a main storage device and a sub-storage device, ports 211 to 230 providing interface function to external IP based devices, and a bus 203 for interconnecting each component within the communication device 200 and mediating transmission/receipt of data and signals therebetween.

A packer transfer control program 221 is loaded onto the storage unit 202 so that the program 221 can be executed by the processing unit 201.

The packet transfer control program 221 performs a packet transfer control process and applies an IP packet transfer function to the communication device 200.

As described above, the hosts 100 to 159, the management server 400 and the storage device 300 can perform IP-based communications via the communication device 200 or the communication device 250 with other devices.

The communication device 250 may have the same configuration as that of the communication device 200. Thereby, path redundancies can be increased, resulting in improving reliability and availability of the storage system 1.

As mentioned above, the hosts 100 to 159 make an access to the volumes 3100 to 3159 of the storage device 300, based on iSCSI protocols. The iSCSI devices identify an initiator or a target to be a communication destination by inquiring a pair of an appropriate iSCSI name and IP address, so as to establish an iSCSI session.

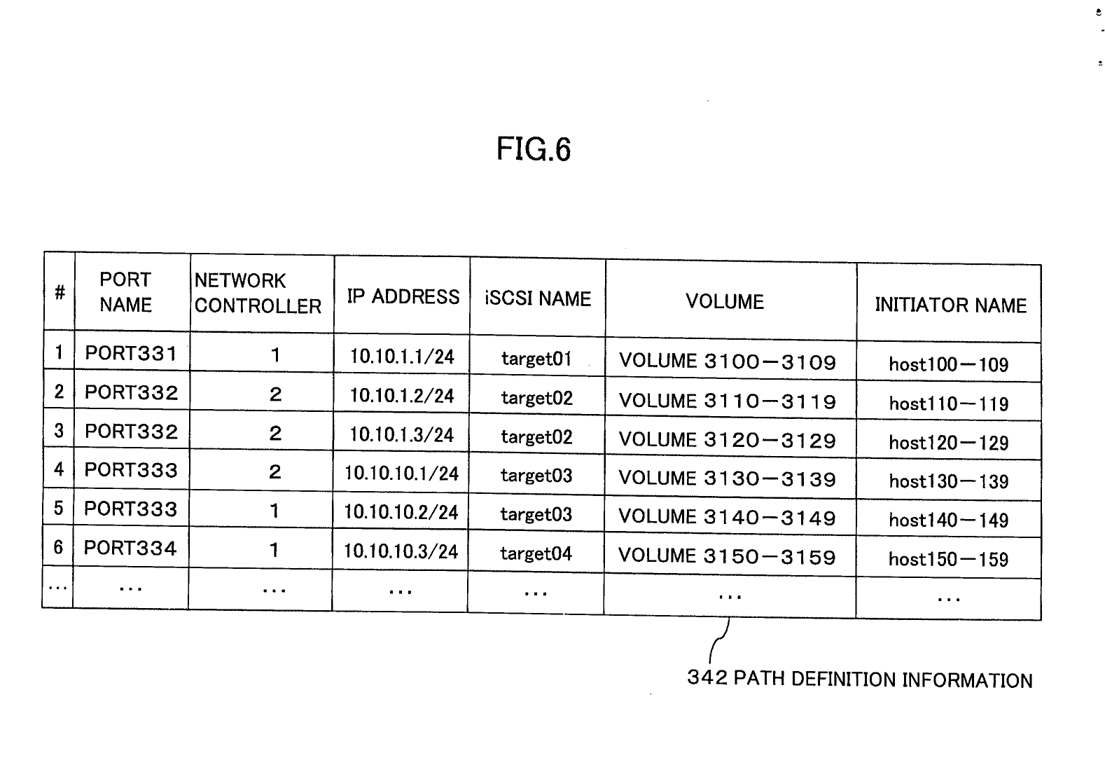

FIG. 6 shows an example of a table for path definition information 342 retained in the storage device 300.

The path definition information 342 includes each field for # as each record number uniquely appended to each corresponding record (i.e. each line of the table) in the path definition information 342, PORT NAME as each port name of the storage device 300, NETWORK CONTROLLER as each identifier for the network controllers (interface modules) onto which the ports are loaded, IP ADDRESS as each IP address that has been assigned to each port, iSCSI NAME as each identifier for the iSCSI names of and VOLUME as each identifier for the volume names of targets accessible from the corresponding ports, and INITIATOR NAME as each initiator to permit connection thereto.

For example, a record appended with #1 indicates: hosts 100 to 109 identified with an initiator name “host100-host109” are accessible to volumes 3100 to 3109 via an IP address “10.10.1.1/24” assigned to a port 331 of the storage device 300.

Next, with reference to the path definition information 342 in FIG. 6, an explanation will be given on how to communicate with 10 hosts by assigning an IP address to each of the ports 331 to 336.

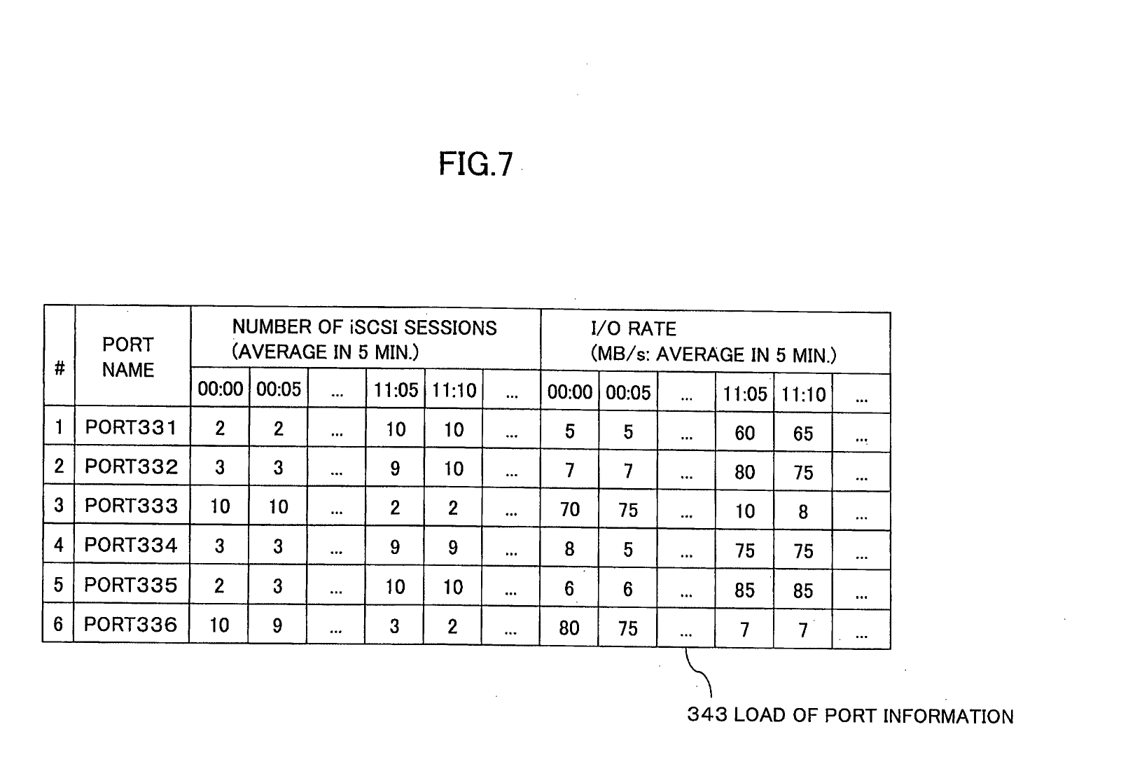

FIG. 7 shows an example of a table for load of port information 343.

This load of port information 343 indicates load conditions for port 331 to 336. The information 343 includes each filed for # as each record number uniquely appended to each corresponding record, PORT NAME as each port name, NUMBER OF iSCSI SESSIONS as the number of current sessions in progress, and I/O RATE as each I/O rate (MB/s) indicating data rate received or sent via the corresponding port.

The field for NUMBER OF iSCSI SESSIONS also has subfields where the number of iSCSI sessions in progress per a predetermined time period are recorded. The field for I/O RATE has subfields where I/O rate per a predetermined time period is recorded. Records on the number of iSCSI sessions in progress and I/O rate are updated every five minutes by an average value in five minutes. However, the time period for data recording and updating maybe changed in shorter or longer, according to the port configuration or the communication condition.

In general, an iSCSI session comprises one or more TCP connections in iSCSI protocols. Hence, for the sake of improving reliability in communication between a host (initiator) and a storage (target) based on the iSCSI protocols, a single iSCSI session may be constituted by more than one TCP connection. For example, the host 100 may establish two TCP connections through the ports 331 and 332, via which the host 100 can access both to “target01” and the volume 3100. In this case, however, man-hours for operations and managements for the path setting increase as the number of hosts increase since plural paths are required to be set for a single iSCSI session every time establishing it.

The iSCSI layer is located upper than the TCP/IP layer, and if congestions occur in the IP network, packets may be actively discarded. This may also cause a temporary halt of I/O or deterioration in communication performance on the iSCSI layer.

To counter this problem, the system can employ a topology in which a path switching is executed every time an I/O halt or performance deterioration occurs. However, this may cause flapping when the network frequently becomes congested because route information is frequently transmitted over two paths between iSCSI devices (node) and frequencies of the path switching becomes increased, resulting in an unstable communication state.

In a conventional iSCSI communication, a path switch is carried out after a TCP retransmission or a TCP connection time out. However, another problem has been raised that it takes more time to perform a path switching operation if a failure occurs on the IP layer due to a failure on a storage port, etc, causing deterioration of availability.

To counter this problem, when a failure on a port of the storage occurs, a path switching topology can be employed by allowing another port to take over functions on the faulty port where a single iSCSI session (a single TCP connection) has been established. However, as more hosts are increasingly used, more storage ports are increasingly used and I/O traffics generated by those hosts change every second more frequently. This hinders a proper port selection. Furthermore, an appropriate failover operation of communication requires a predefinition for each failover port, resulting in significant increase of man-hours for operations and managements for it.

To solve these disadvantages as mentioned above, the storage system 1 according to the present embodiment performs the following processes:

When a failure occurs on IP communication through any of the ports 331 to 336 of the storage device 300, due to a failure on any of the storage ports itself, a failure on the communication device 200 or 250 or a failure on communication lines such as cables, the communication failure is detected, and a failover port (“failover port” in claims of the present invention) is selected for a faulty port in use (“port in use” in claims of the present invention) and then is allowed to take over communication conditions on the faulty port in use such as its IP address and the target information, whereby a smooth communication to the host can be maintained.

Therefore, in order to accomplish the above processes, the storage system 1 has employed such a topology where a selection of the failover port is accomplished by taking account of both physical and logical topologies of the network such as each load for the port 331 to 336 and connection statuses of the devices including the communication devices 200 and 250 of the storage system 1.

According to the first embodiment, the management server 400 executes a port selection program 412 so that the processes of selecting the failover port in the above mentioned topology can be accomplished. This port selection program 412 is activated periodically (e.g. every five minute). The following is a detailed explanation of this process.

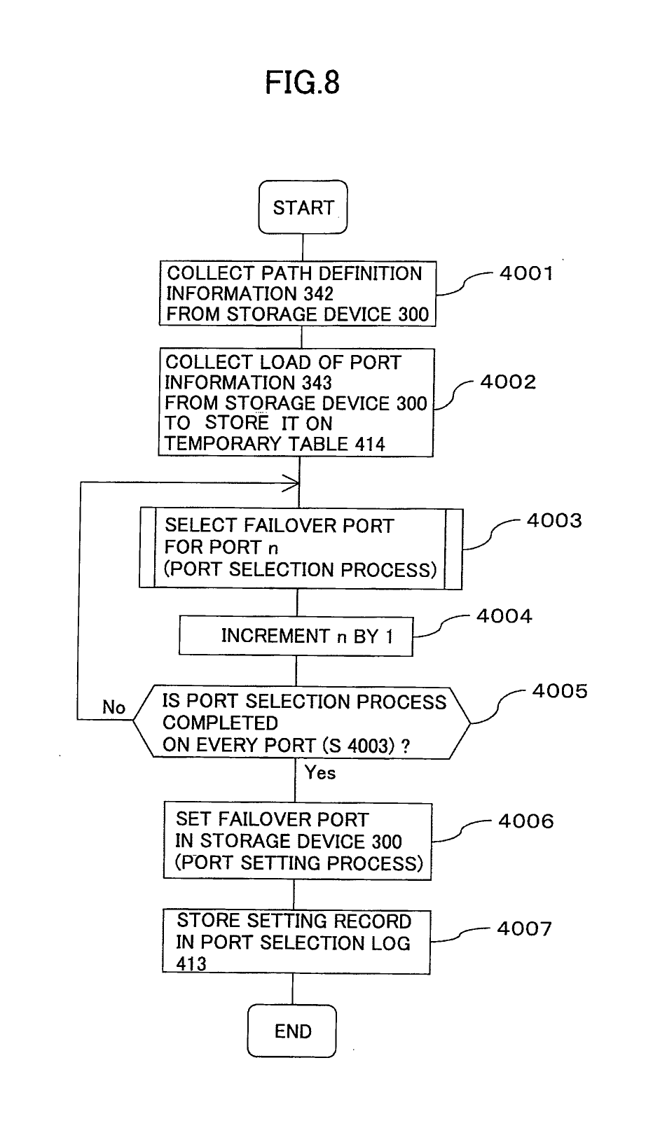

FIG. 8 is a flow chart showing a series of processes to select a failover port for the faulty port involved in the communication failure (i.e. the port in use) by executing the port selection program 412, to allow the selected port to take over the communication conditions on the port in use, so that the failover port can provide a failover operation on the communication involved with the faulty port in use.

First, the port selection program 412 collects the path definition information 342 from the storage device 300 via the communication devices 200 and 250 (S4001). Acquisition of the path definition information 342 is carried out based on protocols such as SNMP (Simple Network Management Protocol) for monitoring and controlling devices connected to a TCP/IP network. In this case, it is expected that the storage device 300 retains MIB (Management Information Base) including the path definition information 342 so that the device 300 can provide the MIB for the management server 400.

Next, the port selection program 412 collects the load of port information 343 from the storage device 300 via the communication device 200 or the communication device 250 (S4002). The load of port information 343 is acquired from the MIB including the load of port information 343 which is stored in the storage device 300, based on, for example, SNMP in the same way as in acquisition of the path definition information 342 (S4001). The port selection program 412 updates the temporary table 414 stored in the storage unit, according to the load of port information 343.

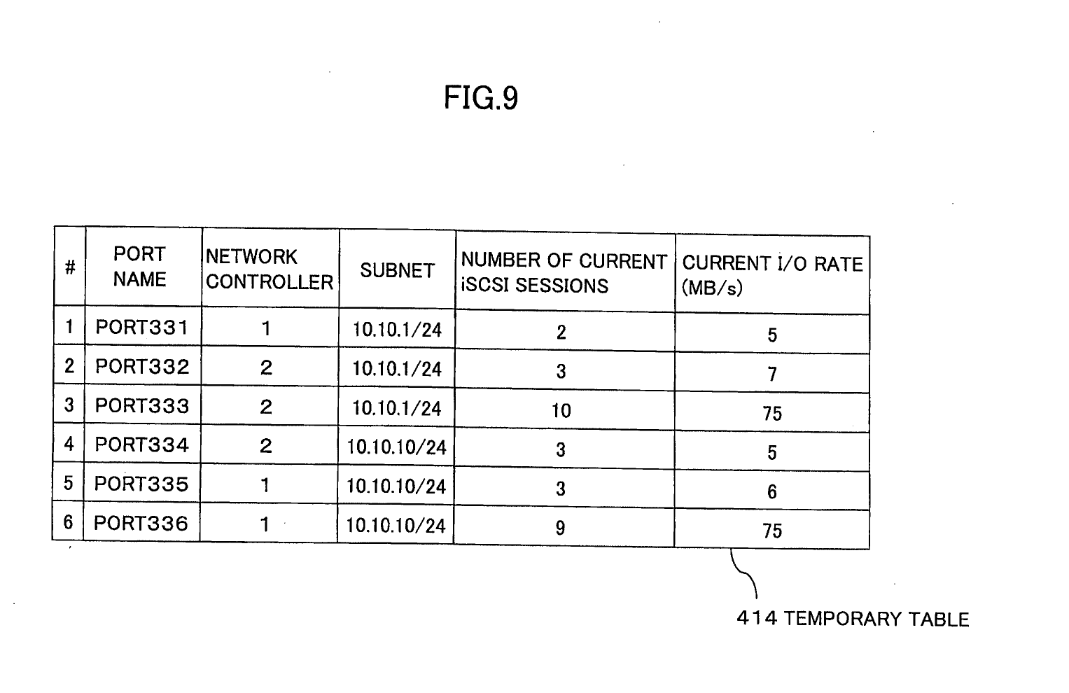

FIG. 9 shows an example of the temporary table 414 at the current time of 00:06.

The temporary table 414 is created such that from the path definition information 342 acquired at the step S4001 and the load of port information 343 acquired at the step S4002, the latest information on load for each port (corresponding to the information at 00:05 in this case) are extracted and edited.

The temporary table 414 includes each field for # as each record number, PORT NAME as each port name, NETWORK CONTROLLER as each identifier for the network controllers, SUBNET as each address for the subnets, NUMBER OF iSCSI SESSIONS as the number of current sessions in progress, and I/O RATE as each current I/O rate, and each value is stored in its corresponding field.

With reference to FIG. 8 again, the port selection program 412 selects an optimum failover port for an “n”th port on the temporary table 414, i.e. a port n (S4003: port selection process). Note that a default value for n is 1 and n is a natural number. Since the default value for n is 1, a port corresponding to “n=1” is initially selected as an appropriate failover port for the port 331.

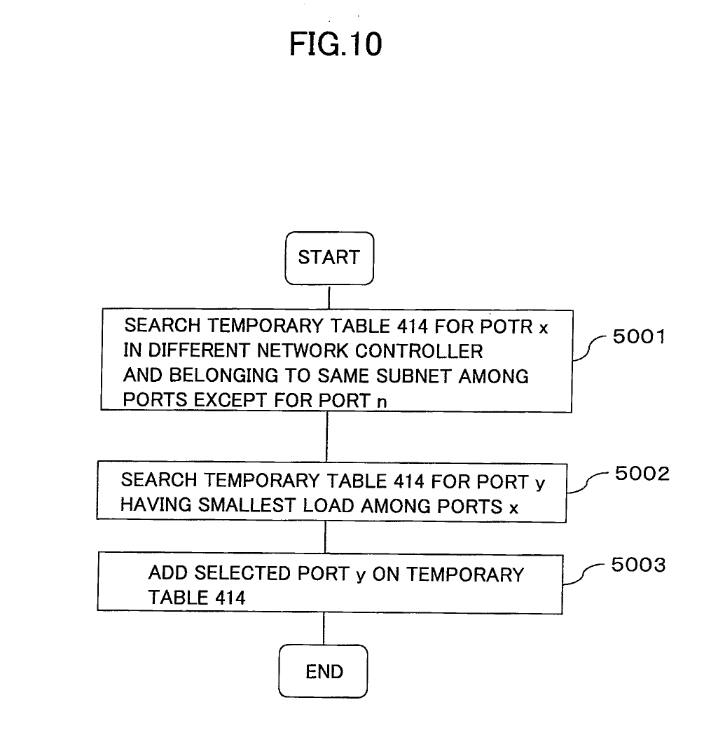

FIG. 10 is a flow chart showing a detailed explanation of a failover port selection process (S4003).

The port selection program 412 inquires the temporary table 414 to search for ports x among ports other than the port 331, and which is loaded on a different network controller from the network controller on which the port n is loaded and belongs to the same broadcast domain (subnet) (S5501).

The ports x preferably comprises ports loaded on a different network controller from the network controller on which the port n is loaded, taking possibility of failure on the network controller on which the port n is loaded into account. However, it is also possible to select the ports x from ports loaded on the same network controller of the port n if there are ports working normally loaded on the same network controller. The ports x are also selected from ports belonging to the same broadcast domain (subnet) as the port 331 belongs thereto, so that the ports x can take over the same IP address of the port n. In this case, with reference to the path definition information 342, a port 332 and a port 333 can be listed as ports x that satisfy the above conditions.

Preferably, the network topology information 415 indicating a relationship of physical and logical connections between the communication devices 200, 250 and the storage device 300 is created (see FIG. 4) so as to search for a port connected to the other communication device 200 (or 250) than the communication device 250 (or 200) to which the port n is connected, so that the ports x can be preferentially selected among these ports. For example, this network topology information 415 can be created in advance and be stored in the storage unit 402 of the management server 400.

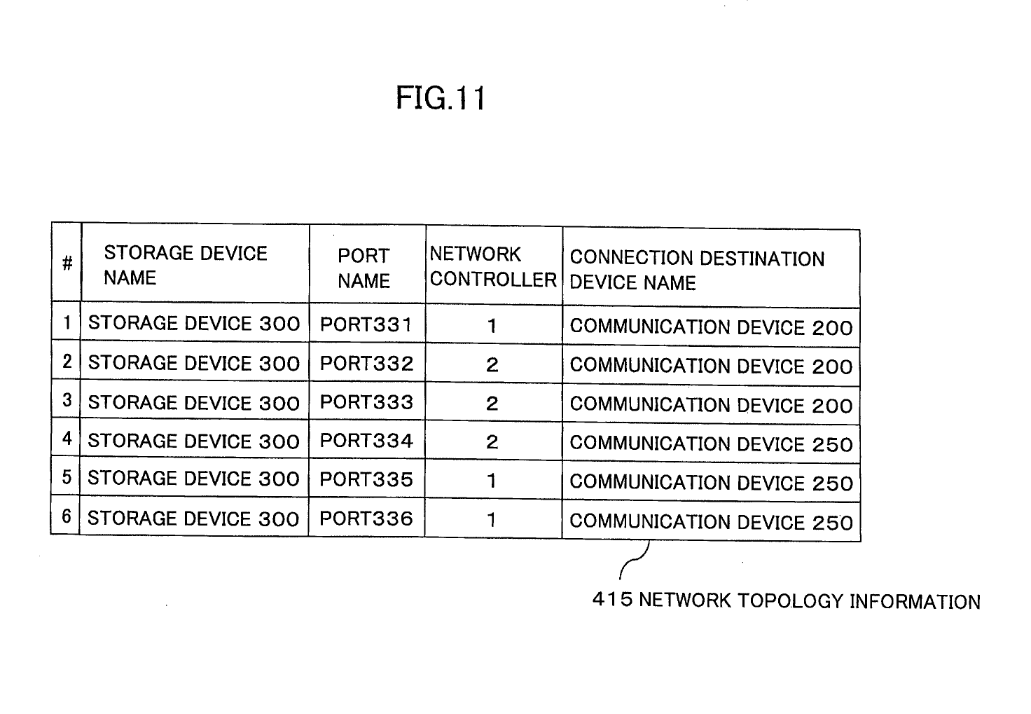

FIG. 11 shows an example of a table for the network topology information 415.

The network topology information 415 includes each field for # as each record number, STORAGE DEVICE NAME as each storage device name, PORT NAME as each port name, NETWORK CONTROLLER as each identifier for the network controllers, and CONNECTION DESTINATION DEVICE NAME as each device name of the connection destinations. Each value is recorded in its corresponding field.

Referring to FIG. 10 again, the port selection program 412 searches for a port having the lowest load among the ports x (ports 332, 333) searched at the step S5001, with inquiring the temporary table 414 (S5002). As shown in the temporary table 414 (see FIG. 9), the port selection program 412 selects the port 332 among the ports x as an optimum failover port y having the lowest load. Port selection is executed taking the number of iSCSI sessions and/or I/O rate into account.

The port selection program 412 adds an identifier for the failover port selected at the step S5002 to the temporary table 414. (S5003)

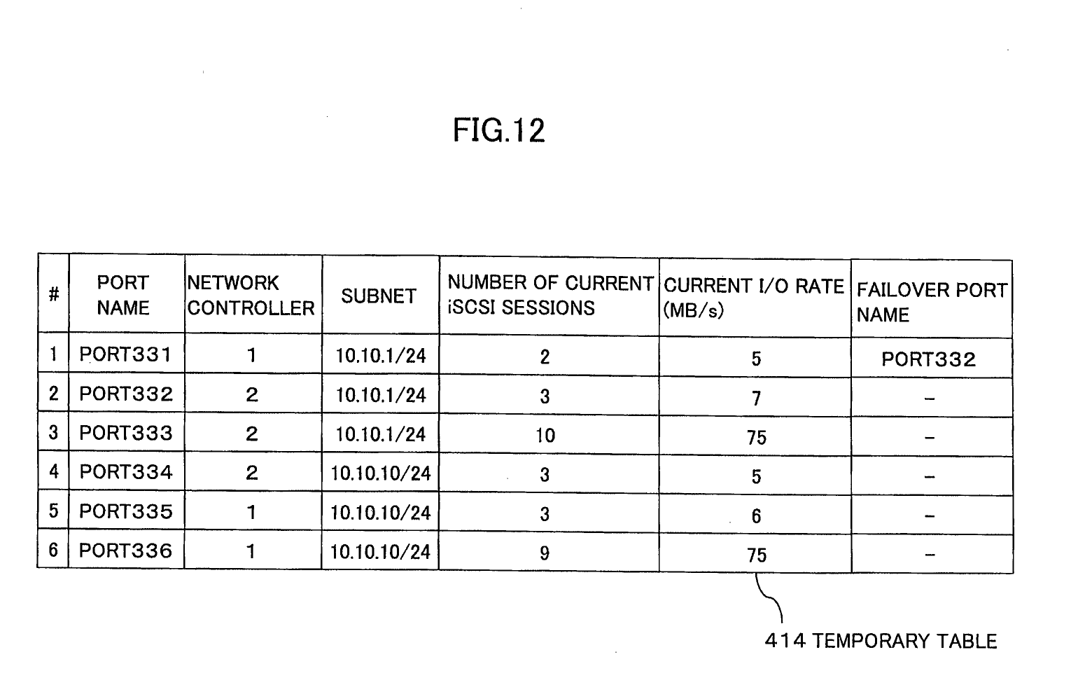

FIG. 12 shows an example of the temporary table 414 in which a field for the failover ports is added.

In the temporary table 414, a field for FAILOVER PORT NAME is added and “port 332” is listed in the record of #1.

Back to FIG. 8, the port selection program 412 adds 1 to the value n (S4004).

The port selection program 412 checks whether or not the port selection process (S4003) has been performed for every port recorded in the temporary table 414 (see FIG. 12) (S4005) If there are any ports for which the port selection process has not been executed yet (“No” at S4005), the port selection program 412 returns to the step S4003 to perform the port selection process for the ports. If the port selection process has been completed for all the ports (“Yes” at S4005), the port selection program 412 proceeds to the next process (S4006).

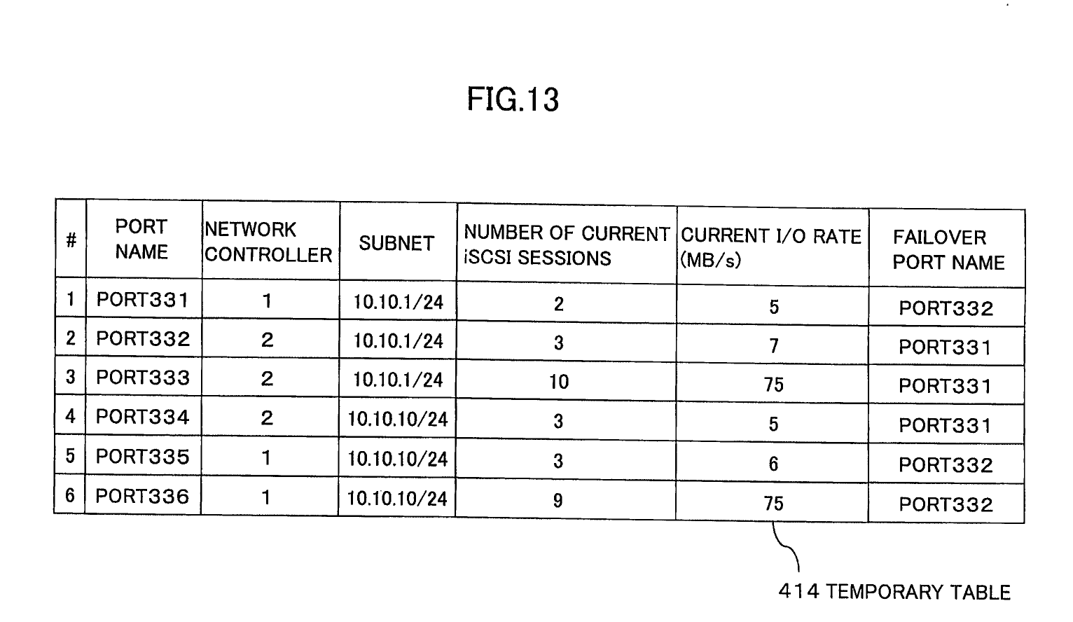

FIG. 13 shows the temporary table 414 that has been created through each process by the port selection program 412.

With reference to this temporary table 414, it is seen that a respective optimum port has been selected for each port 331 to 336.

Again in FIG. 8, the port selection program 412 provides a setting of the selected failover port in the storage device 300 (S4006: a port setting process).

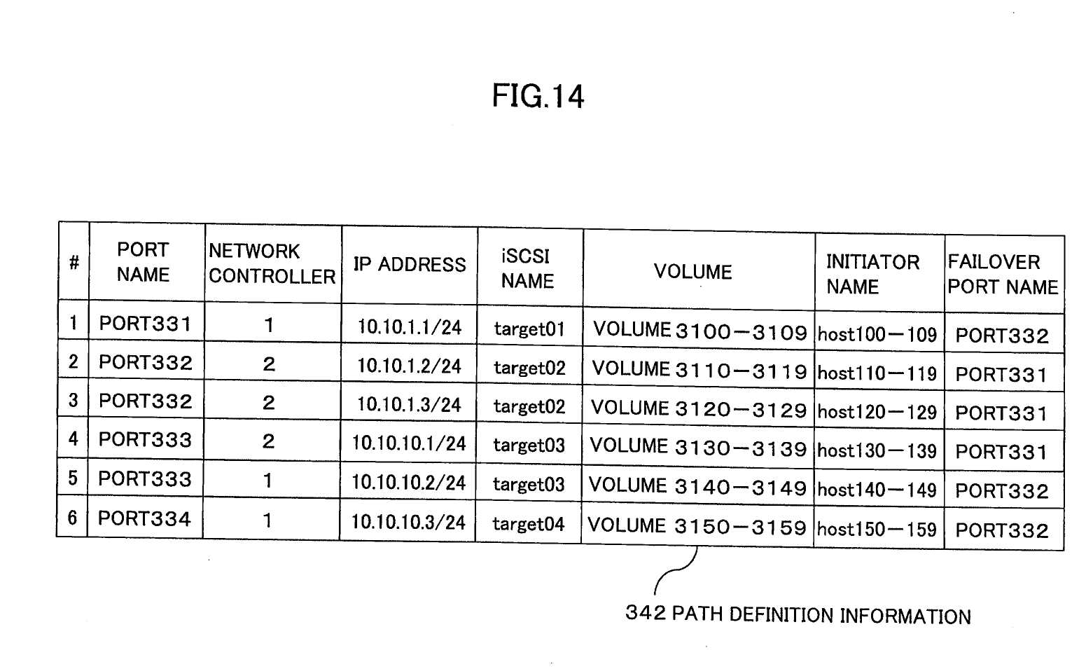

FIG. 14 shows an example of a table for the path definition information 342 retained in the storage device 300, after the completion of the failover port setting process (S4006).

Now referring to FIG. 8 again, the port selection program 412 stores the setting record at the port setting process (S4006) in the port selection log 413 (S4007).

With inquiry to the previous port selection log 413, if the current setting in the port setting process (S4006) is the same as the previous one, the step S4006 may be omitted. If there are any faulty ports in use for which no appropriate failover ports can be found, it may be informed to an administrator (the management server 400) via e-mails, etc.

Hereinafter, a port switching operation performed by the storage device 300 itself is explained.

The storage device 300 always monitors the IP communication status for each port that the storage device 300 itself has, and has a function of switching the faulty port in use to a failover port when a failure occurs on a port in communication so that the failover port can take over the communication related to the faulty port in use.

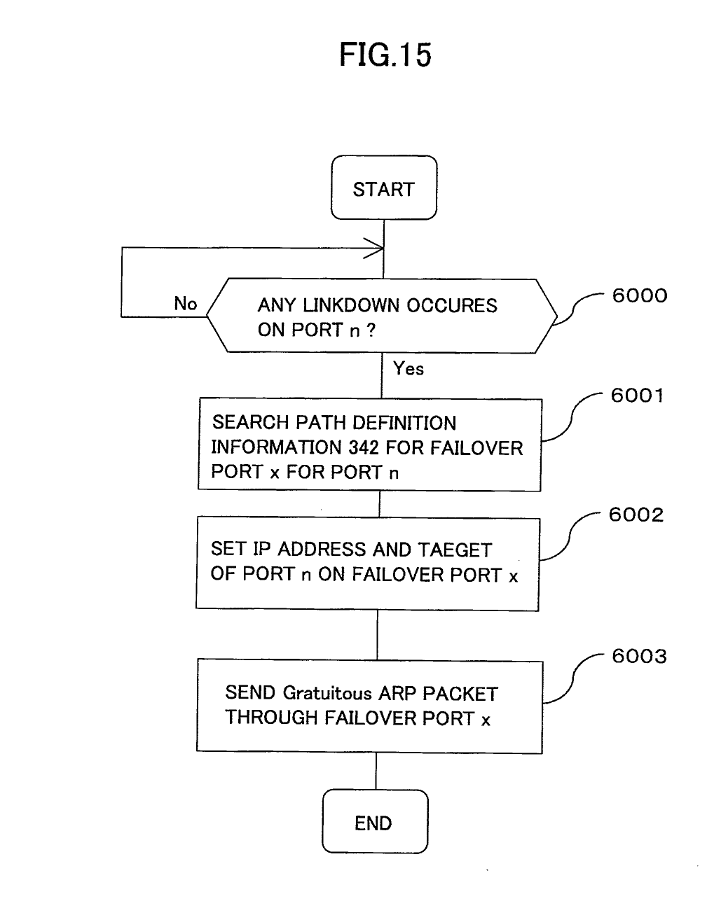

FIG. 15 is a flow chart explaining the port switching operation performed by the storage device 300 itself.

The storage control program 341 of the storage device 300 always monitors the IP communication status for each port within the storage device 300 (S6000). In order to monitor the IP communication status, the storage control program 341 monitors, for example, failures on the ports or on the communication devices of connection destinations, or likndowns due to failures on communication lines such as cables. If there occur no linkdown on a port n in use (“No” at S6000), the storage control program 341 maintains the monitoring operation. If any linkdown occurs on the port n in use (“Yes” at S6000), the storage control program 341 proceeds to the next step.

Next, the storage control program 341 searches the path definition information 342 (see FIG. 14) for a failover port x for the port n in use that has become incapable of IP communication (S6001). Assumed that the port 331 becomes incapable of IP communication. In this case, the port 332 becomes a failover port x for the port 331 as the port n in use.

Then, the storage control program 341 resets the IP address and the target name from the port n in use incapable of IP communication (port 331) to a failover port x (port 332) (S6002).

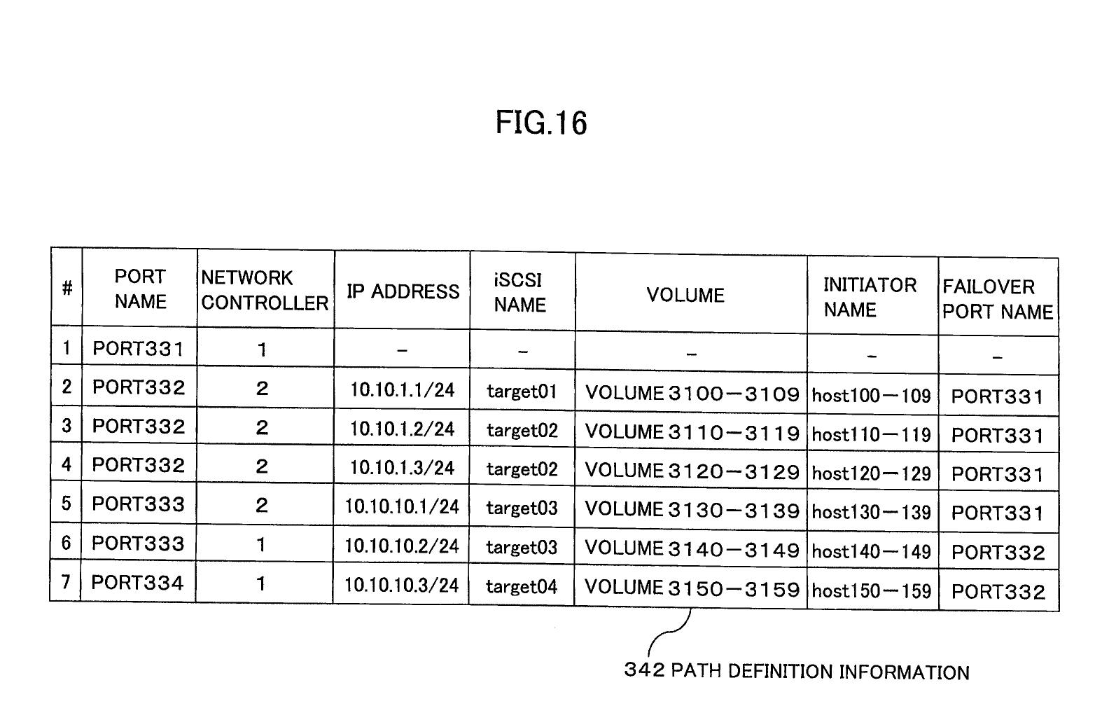

FIG. 16 shows an example of a table for the path definition information 342 on which the IP address and the target name have been reset from the port in use to the failover port.

In this example, the storage control program 341 sets the IP address “10.10.1.1/24”, the target name “target02” accessible from the port 332. Note that the faulty port 331 in use will be kept out of candidates for a failover port at a port selection process (described later) until it becomes recovered.

Next, the storage control program 341 sends a Gratuitous ARP (Address Resolution Protocol) packet through the failover port (the port 332 herein) to the communication device 200 or 250 (the device 200 herein) so that the IP address “10.10.1.1/24” taken over becomes accessible through this port 332 (S6003). Thereby, the hosts 100 to 109 can access to the IP address “10.10.1.1/24” through the port 332, and the iSCSI session that has been established through the previous port 331 can be maintained via the failover port (the port 332). Thereafter, if a linkup occurs through the port 331, the path definition information 342 can be switched back to the state before the linkdown occurs (see FIG. 14).

As descried above, the explanation has been given on the process of the port selection at the time of 00:06. Hereinafter, an explanation will be given on the process of the port selection at the time of 11:12 when the predetermined time has passed.

Referring again to FIG. 8, the port selection program 412 collects the current path definition information 342 from the storage device 300 (S4001), and then collects the load of port information 343 from the storage device 300 (S4002), as well.

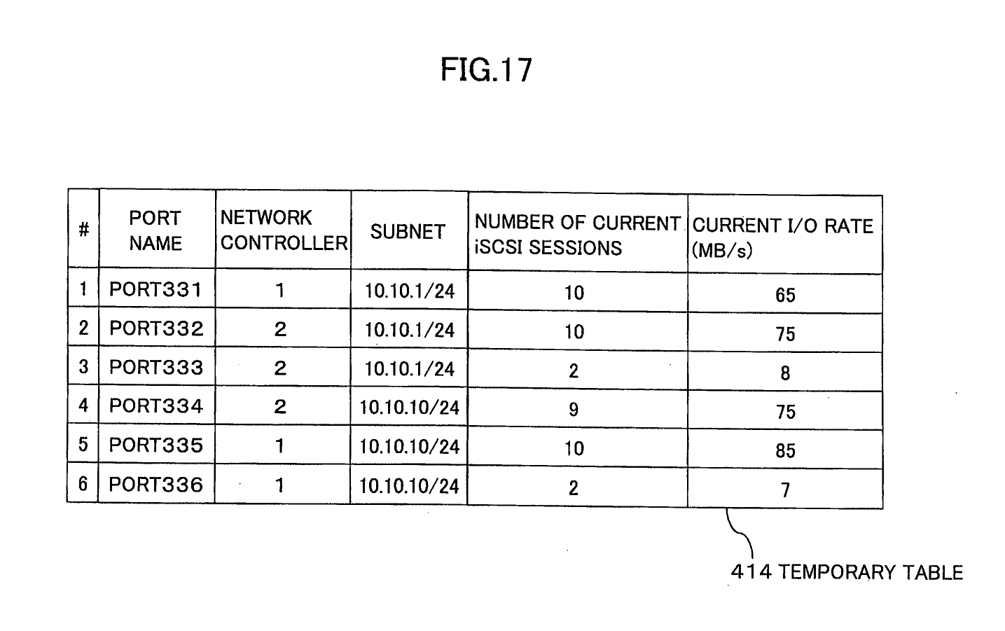

With reference to the temporary table 414 at the current time of 11:12 in FIG. 17, it can be seen that there are some changes in the communication load per each port (such as the number of iSCSI sessions and the I/O rate) although there have not been changes in the network topology.

Returning again to FIG. 8, the port selection program 412 executes the steps S4003, S4004 and S4005 based on the inquiry to the temporary table 414, as descried above.

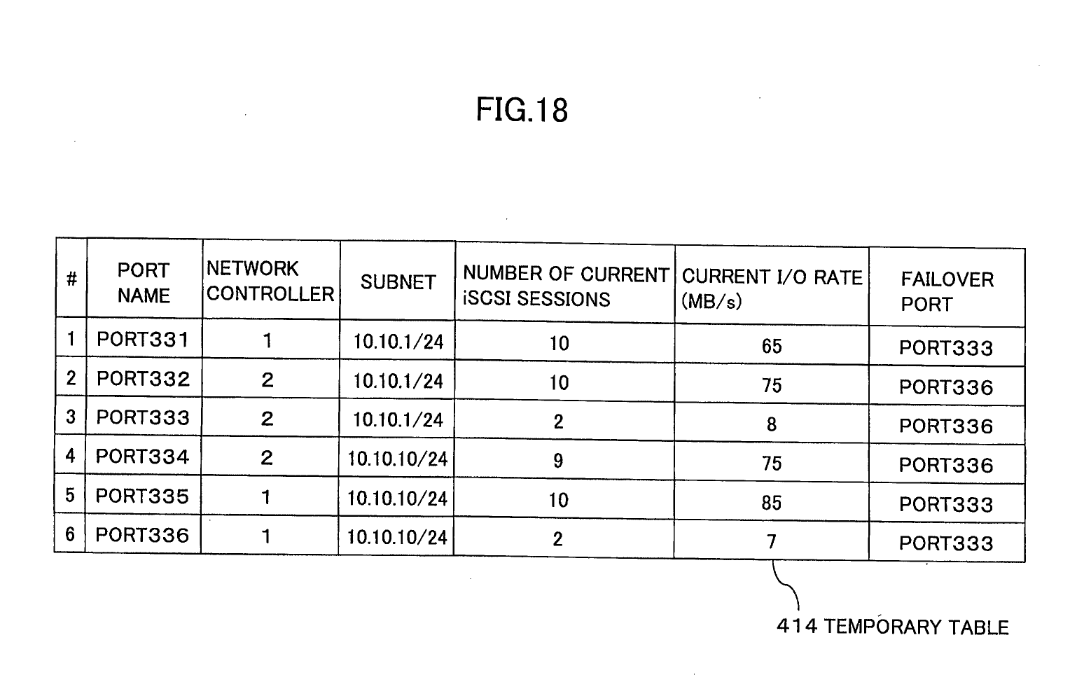

FIG. 18 shows an example of a table for the temporary table 414 after the executions of the steps S4003, S4004 and S4005 (the port selection process and others) are accomplished.

Again in FIG. 8, the port selection program 412 provides a setting of the failover port in the storage device 300 (S4006), as mentioned above, and then stores this setting record in the port selection log 413 (S4007).

According to the change in communication load for each port, the current failover port selected at the time of 11:12 is a different port from the previous one selected at the time of 00:06. For example, the port 332 was the optimum failover port for the port 331 at the time of 00:06, and then the port 333 becomes the current optimum failover port for the port 331 at the time of 11:12, according to the load of port conditions.

By executing the above mentioned processes according to the present embodiment, it is possible to realize a lower cost storage system 1 for providing an optimum failover port selection, so as to insure a stable failover operation for a faulty port in use.

As described above, the example has been explained in which the storage system 1 is an iSCSI system. However, the storage system 1 may employ a topology as a NAS (Network Attached Storage) system such as NFS (Network File System) or CIFS (Common Internet File System). In this case, the storage device 300 serves as a NAS for NFS servers or CIFS servers, having a topology to perform a failover operation on IP address information when a failure occurs on the ports of the storage device 300. There is no need to perform a failover operation of the target information, to the contrary of the case of iSCSI communication.

### Second Embodiment

Hereinafter an explanation will be given on a storage system 1 according to the second embodiment of the present invention.

Basically, the storage system 1 according to the second embodiment may have the same topologies and operations as those according to the first embodiment, other than what will be descried as below.

In the first embodiment, the explanation has been given on the topologies and the operations for the processes to be taken after an IP failure occurred on a port. According to the second embodiment, an explanation will be given on a topology for monitoring the communication error for each port and detecting the deterioration in the port performance and the communication status, in order to prevent deterioration in communication performance due to temporary packet discarding when IP communication becomes unavailable due to port failures or the like.

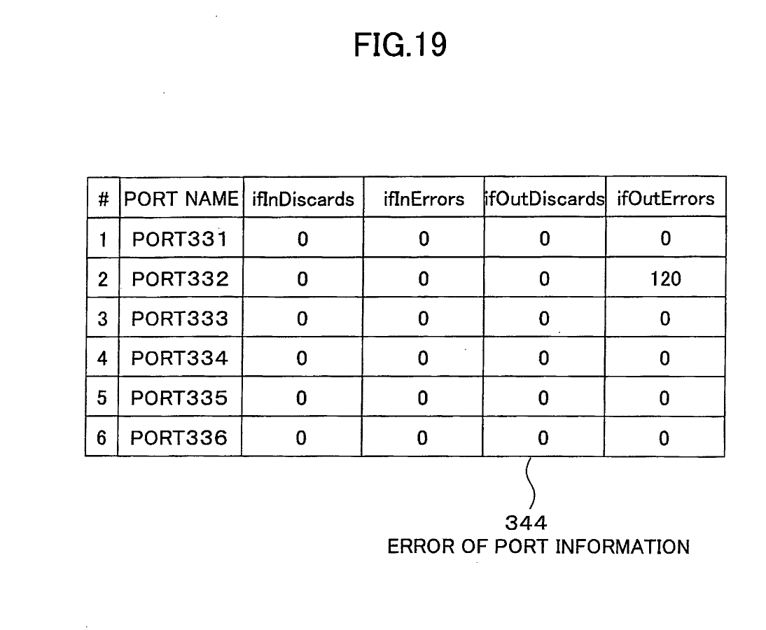

FIG. 19 shows an example of a table for error of port information 344 retained in the storage device 300.

The error of port information 344 is a database based on the sum of error ports of each error type. The error of port information 344 includes each field for # as each record number, PORT NAME as each port name, and target devices to be monitored, which are “ifInDiscards”, “ifInErrors”, “ifOutDiscards”, “ifOutErrors” as the MIB (Management Information Base) stored in the storage device 300, and each value is recorded in its corresponding field. For example, in inquiry to #2 of the error of port information 344, it is apparent that only “ifOutError” of the port 332 (number of packet transmission errors) has a value of 120 and the others have no errors on this information 344.

In the storage system 1 according to the present embodiment, the management server 400 executes the port selection program 412 so that the processes in the above mentioned topology is accomplished.

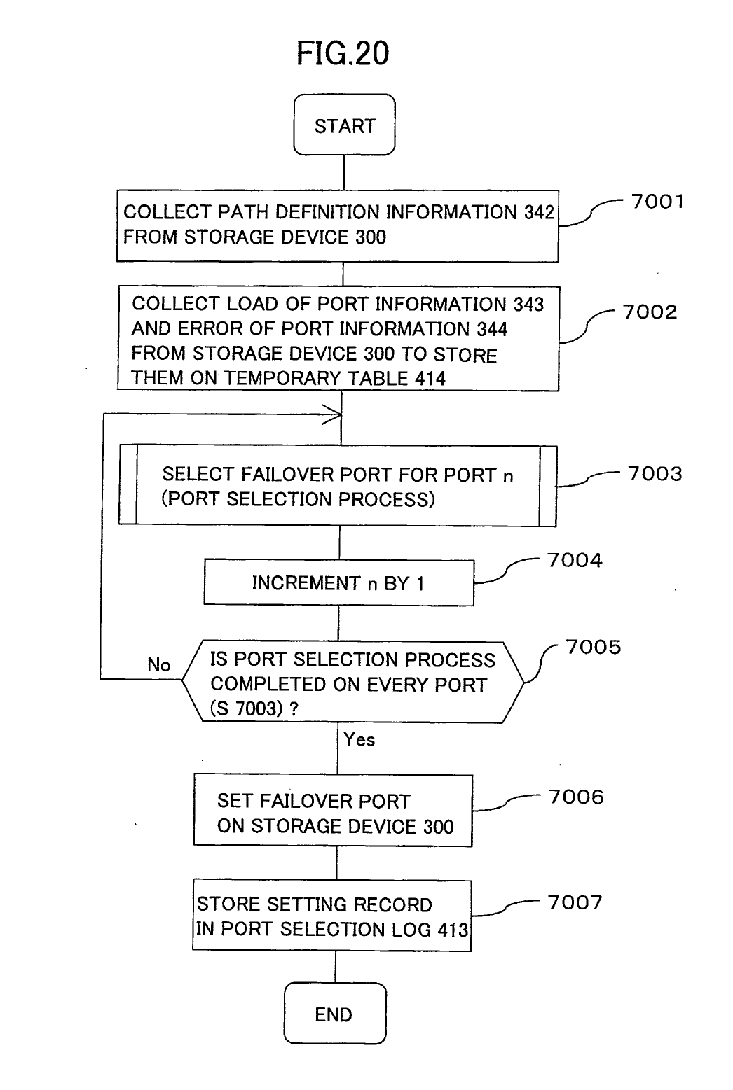

FIG. 20 is a flow chart showing an example of a series of processes of a failover port selection and failover operation from a faulty port in use to a selected failover port by executing the port selection program 412. In these processes, a failover port for a faulty port involved in deterioration in communication performance is selected, and the selected failover port takes over the communication conditions on the faulty port in use so as to take over the communications on this port in use.

First, the port selection program 412 collects the path definition information 342 from the storage device 300 (S7001).

Then, the port selection program 412 stores a load of port information 343 and a error of port information 344, and stores the latest data of the information of both the information 343 and the information 344 on the temporary table 414 (S7002).

Acquisition of the above information can be performed by extracting the information from MIB of the storage device 300 based on, for example, SNMP.

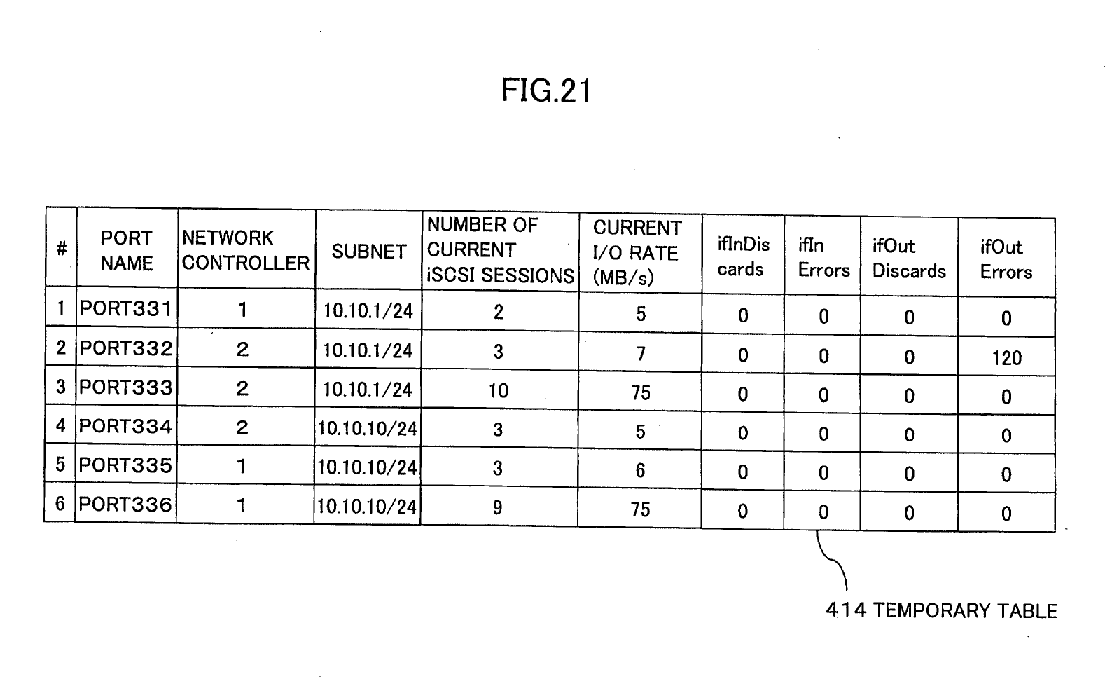

FIG. 21 shows an example of the temporary table 414 at the current time of 00:06.

The temporary table 414 is a table in which the latest load status and error status for each port, extracted from the path definition information 342, the load of port information 343 and the error of port information 344 as acquired above, are listed.

The temporary table 414 includes each field for # for record numbers, PORT NAME for each port name, NET WORK CONTROLLER as each identifier for the network controllers, SUBNET as each subnet address, NUMBER OF iSCSI SESSIONS as the number of current sessions in progress, and I/O RATE as each current I/O rate, and target devices to be monitored, which are “ifInDiscards”, “ifInErrors”, “ifOutDiscards”, “ifOutErrors” as the MIB (Management Information Base) stored in the storage device 300, and each value is recorded in its corresponding field.

Returning to FIG. 20, the port selection program 412 selects an appropriate failover port for an “n” th port (default value for n is 1) recorded on the temporary table 414 (S7003: port selection process). For example, in the case of n=1, an appropriate port is to be selected for the port 331.

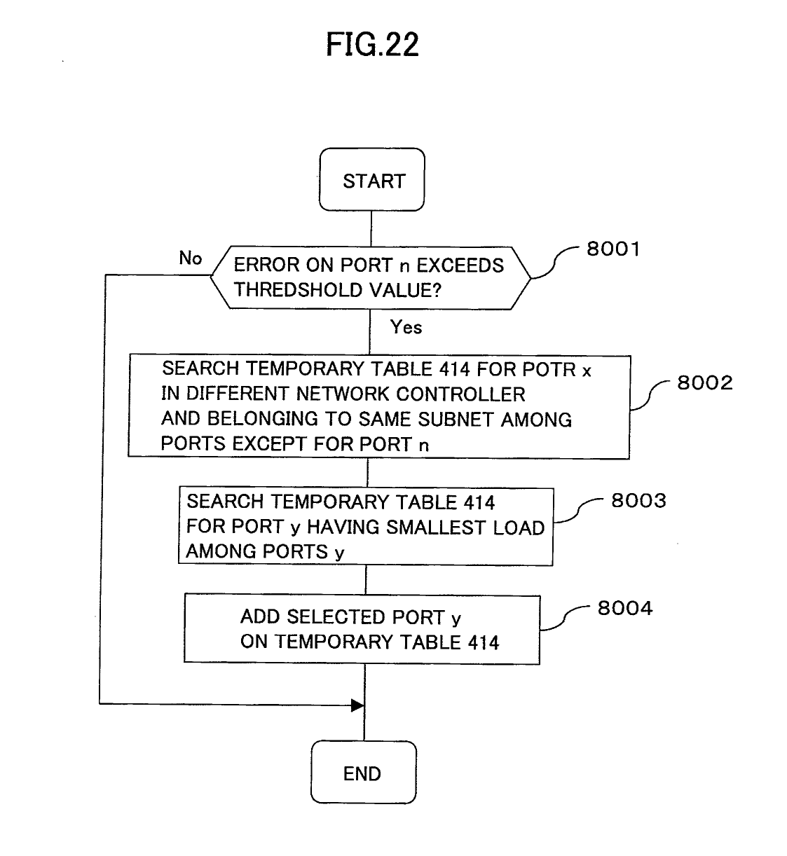

FIG. 22 is a flow chart for a detailed explanation of the port selection process (S7003).

As shown in FIG. 22, the port selection program 412 checks whether or not each value for the errors on the port 331 exceeds its predetermined threshold (S8001). Assumed that an administrator set the threshold value for the error information as 100. In this case, each error information is 0 on the port 331, and no error information exceeds the threshold value. Hence, the port selection program 412 proceeds from this process (S7003) to the next process (S7004).

Back to FIG. 20 again, the port selection program 412 adds 1 to n (S7004).

The port selection program 412 checks whether or not the port selection process (S7003) is completed on every port listed on the temporary table 414 (S7005). If the process is completed (“Yes” at S7005), the program 412 proceeds to the next step (S7006), and if the process is not completed (“No” at S7005), the program 412 returns to the port selection process (S7003).

Repeating the processes of S7003 to S7005 for each port, the error information exceeds the threshold value of 100 in the process for the port 332 (“Yes” at S8001; see FIG. 22), thus the port selection program 412 proceeds to the next process (S8002).

Next, the port selection program 412 executes the processes of S8002 to S8004, similar to the processes of S5001 to S5003 in the first embodiment of the present invention.

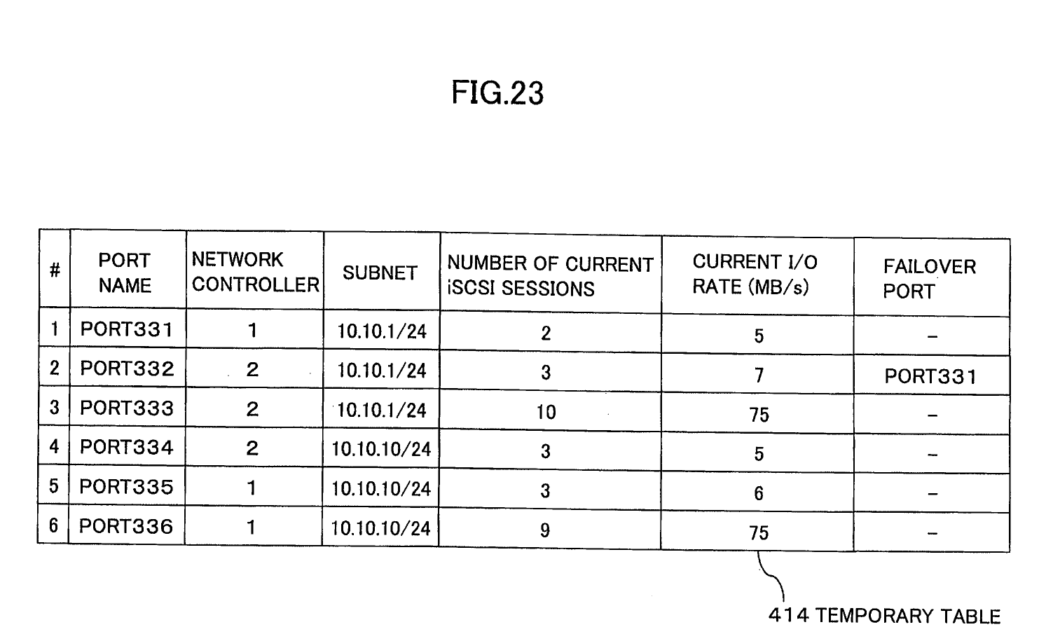

FIG. 23 shows the temporary table 414 on which an optimum failover port has been selected for the port 332.

Returned to FIG. 20, the port selection program 412 executes the processes of S7006 and S7007. The step S7006 may be executed in the same way as at the step S4006 in the first embodiment, and the step 7007 may be executed in the same way as at the step S4007 in the first embodiment.

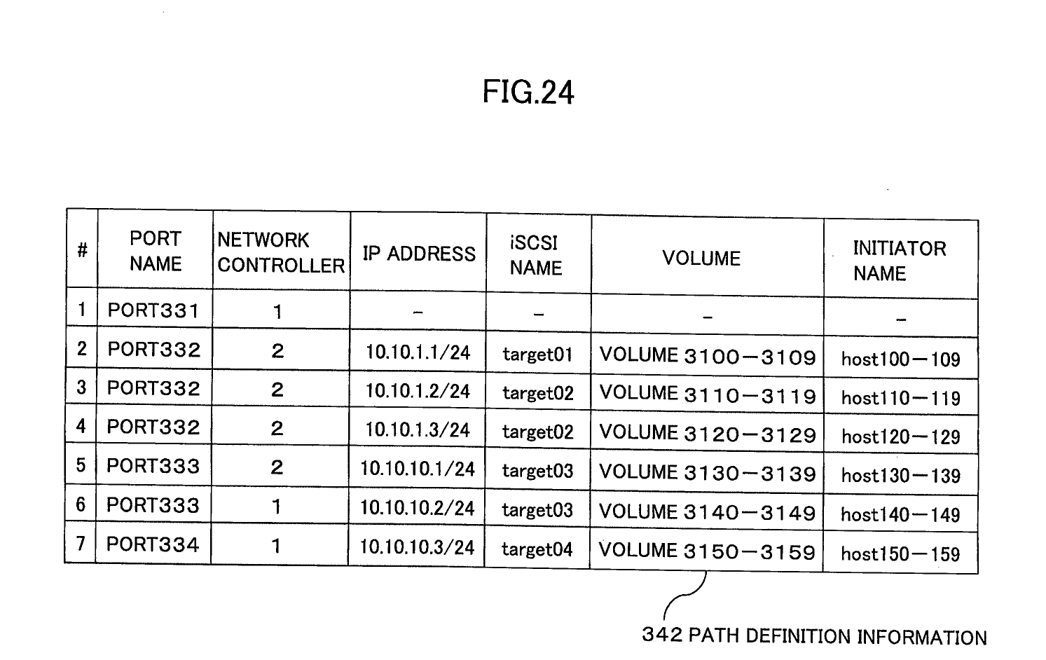

FIG. 24 shows an example of a table indicating the path definition information 342 on which the failover port has been set.

In the storage device 300, the port selection program 412 inquires the path definition information 342 and executes the processes of the step S6001 to the step S6003 (see FIG. 15) so that the port information involved with communication errors is taken over to an appropriate failover port before any communication failures occurs, whereby the communication can be maintained smoothly.

As aforementioned, the storage system 1 according to the second embodiment of the present invention executes each process as described above so that performance deterioration due to a temporary packet discarding action when IP communication is unavailable can be prevented previously by switching a port likely to have a failure to a normal one before a communication failure occurs. Accordingly, reliability and availability can be improved on the storage system 1.

In the above examples, the storage system 1 has been descried as an iSCSI system. However, the storage system 1 may employ a topology of a NAS (Network Attached Storage) system such as a NFS (Network File System) or a CIFS (Common Internet File System). In this case, the storage device 300 functions as a NAS system for a NFS server or CIFS server. The device 300 has a configuration to execute a failover operation of the IP address information when a failure occurs on any port of the storage device 300. In this case, a function as taking over the target information may be unnecessary, which is different from the case of iSCSI communication.

Note that information and data described in each embodiment of the present invention may be in any form as far as necessary information and data stored in the form can be read out when they are required to. According to the explanations on the embodiments of the present invention, specific content on each data and information is descried in a form of a table, and it can be in a form of serial data or of spreadsheet. A topology including a relational database system and a RDBMS (Relational Database Management System) may also be employed, so that necessary data or information can be extracted by using the RDBMS from the relational database constituted by plural distributed databases across which related data or information is stored.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. A storage system comprising:
a host having an iSCSI initiator function;
a storage having an iSCSI target function and plural storage ports, the storage communicable with the host through an IP network; and
a management server communicable with the storage; the management server comprising:
a load information collecting unit for collecting load information on load for each of the storage ports; and
a port selection unit for selecting a failover port when a communication error occurs on one port of the storage ports which is in use to communicate with the host, the selection unit inquiring the load information for each of the storage ports and selecting for the port in use the failover port out of the storage ports except for the port in use based on the load for each of the storage ports, the selection unit allowing the failover port to take over communication conditions of the port in use so that the failover port maintains the communication on the port in use.

2. The storage system according to claim 1, wherein
the storage comprising plural network controllers having plural ports; and
the port selection means for selecting the failover port out of the storage ports which belong to the same broadcast domain as the port in use and which is loaded on a different network controller from the network controller on which the port in use is loaded.

3. A storage system comprising:
a host having an iSCSI initiator function;
a storage having an iSCSI target function and plural storage ports, the storage communicable with the host through an IP network; and
a management server communicable with the storage; the management server comprising:
a network topology information collecting unit for collecting network topology information on physical topology or on logical topology of the storage system; and
a port selection unit for selecting a failover port when a communication error occurs on one port of the storage ports which is in use to communicate with the host, the selection unit inquiring the network topology information on the physical topology or on the logical topology of the storage system and selecting for the port in use the failover port out of the storage ports except for the port in use based on the physical topology or the logical topology of the storage system, the selection unit allowing the failover port to take over communication conditions of the port in use so that the failover port maintains the communication on the port in use.

4. A storage system comprising:
a host having an iSCSI initiator function;
a storage having an iSCSI target function and plural storage ports, the storage communicable with the host through an IP network, and
a management server communicable with the storage; the management server comprising:
a load information collecting unit for collecting load information on load for each of the storage ports;
a network topology information collecting unit for collecting network topology information on physical topology or on logical topology of the storage system; and
a port selection unit for selecting a failover port when a communication error occurs on one port of the storage ports which is in use to communicate with the host, the selection unit inquiring the information on load for each of the storage ports and the network topology information on the physical topology or on the logical topology of the storage system and selecting for the port in use the failover port out of the storage ports except for the port in use based on the load for each of the storage ports and on the physical topology or the logical topology of the storage system, the selection unit allowing the failover port to take over communication conditions of the port in use so that the failover port maintains the communication on the port in use.

5. A storage system comprising:
a host having an iSCSI initiator function;
a storage having an iSCSI target function and plural storage ports, the storage communicable with the host through an IP network, and
a management server communicable with the storage; the management server comprising:
either of a load information collecting unit for collecting load information on load for each of the storage ports or a network topology information collecting unit for collecting network topology information on physical topology or on logical topology of the storage system; and
a port selection unit for selecting a failover port when an error on the port in use to communicate with the host exceeds a predetermined value, the selection unit inquiring the information on load for each of the storage ports and the network topology information on physical topology or on logical topology of the storage system and selecting for the port in use the failover port out of the storage ports except for the port in use based on the load for each of the storage ports, or on the physical topology or the logical topology of the storage system, the selection unit allowing the failover port to take over communication conditions of the port in use so that the failover port maintains the communication on the port in use.

6. A storage system comprising:
a host having a NAS client function;
a storage having a NAS server function and plural storage ports, the storage communicable with the host through an IP network; and
a management server communicable with the storage; the management server comprising:
a load information collecting unit for collecting load information on load for each of the storage ports; and
a port selection unit for selecting a failover port when a communication error occurs on one port of the storage ports which is in use to communicate with the host, the selection unit inquiring the load information and selecting for the port in use the failover port out of the storage ports except for the port in use based on the load for each of the storage ports, the selection unit allowing the failover port to take over communication conditions of the port in use so that the failover port maintains the communication on the port in use.

7. The storage system according to claim 6, wherein
the host has an NFS client function or a CIFS client function, and wherein
the storage is communicable with the host based on NFS protocols or CIFS protocols.

8. A storage system comprising:
a host having a NAS client function;
a storage having a NAS server function and plural storage ports, the storage communicable with the host through an IP network; and
a management server communicable with the storage; the management server comprising:
a network topology information collecting unit for collecting network topology information on physical topology or on logical topology of the storage system; and
a port selection unit for selecting a failover port when a communication error occurs on one port of the storage ports which is in use to communicate with the host, the selection unit inquiring the network topology information on physical topology or on logical topology of the storage system and selecting for the port in use the failover port out of the storage ports except for the port in use based on the physical topology or the logical topology of the storage system, the selection unit allowing the failover port to take over communication conditions of the port in use so that the failover port maintains the communication on the port in use.

9. The storage system according to claim 8, wherein
the host has an NFS client function or a CIFS client function, and wherein
the storage is communicable with the host based on NFS protocols or CIFS protocols.

10. A storage system comprising:
a host having a NAS client function;
a storage having a NAS server function and plural storage ports, the storage communicable with the host through an IP network; and
a management server communicable with the storage; the management server comprising:
a load information collecting unit for collecting load information on load for each of the storage ports;
a network topology information collecting unit for collecting network topology information on physical topology or on logical topology of the storage system; and
a port selection unit for selecting a failover port when a communication error occurs on one port of the storage ports which is in use to communicate with the host, the selection unit inquiring the information on load for each of the storage ports and the network topology information on physical topology or on logical topology of the storage system and selecting for the port in use the failover port out of the storage ports except for the port in use based on the load for each of the storage ports, or on the physical topology or the logical topology of the storage system, the selection unit allowing the failover port to take over communication conditions of the port in use so that the failover port maintains the communication on the port in use.

11. The storage system according to claim 10, wherein
the host has an NFS client function or a CIFS client function, and wherein
the storage is communicable with the host based on NFS protocols or CIFS protocols.

12. A storage system comprising:
a host having a NAS client function;
a storage having a NAS server function and plural storage ports, the storage communicable with the host through an IP network; and a management server communicable with the storage; the management server comprising:
either of a load information collecting unit for collecting of load information on load for each of the storage ports or a network topology information collecting unit for collecting network topology information on physical topology or on logical topology of the storage system; and
a port selection unit for selecting a failover port when an error on the port in use to communicate with the host exceeds a predetermined value, the selection unit inquiring the information on load for each of the storage ports and the network topology information on the physical topology or on the logical topology of the storage system and selecting for the port in use the failover port out of the storage ports except for the port in use based on the load for each of the storage ports, or on the physical topology or the logical topology of the storage system, the selection unit allowing the failover port to take over communication conditions of the port in use so that the failover port maintains the communication on the port in use.

13. The storage system according to claim 12, wherein
the host has an NFS client function or a CIFS client function, and wherein
the storage is communicable with the host based on NFS protocols or CIFS protocols.

14. A storage system comprising:
a host having an iSCSI initiator function;
a storage having an iSCSI target function and plural storage ports, the storage communicable with the host through an IP network, and
a management server communicable with the storage; the management server comprising:
a load information collecting unit for collecting load information on number of iSCSI sessions or on I/O rate for each of the storage ports; and
a port selection unit for selecting a failover port when a communication failure occurs on one port of the storage ports on which an iSCSI session to the host is being established, the selection unit inquiring the load information on the number of the iSCSI sessions or on the I/O rate for each of the storage ports and selecting for the port in use the failover port out of the storage ports except for the port in use, which have less number of the iSCSI sessions or less I/O rate, the port selection unit allowing the failover port to take over IP address information and iSCSI target information of the port in use so that the failover port maintains the iSCSI session to the host.

15. A storage system comprising:
a host having an iSCSI initiator function;
a storage having an iSCSI target function and plural storage ports, the storage communicable with the host through an IP network; and
a management server communicable with the storage; the management server comprising:
a network topology information collecting unit for collecting network topology information on subnet topology and on port topology of the storage system; and
a port selection unit for selecting a failover port when a communication failure occurs on one port of the storage ports on which an iSCSI session to the host is being established, the selection unit inquiring the network topology information on the subnet topology and on the port topology of the storage system and selecting for the port in use the failover port out of the storage ports except for the port in use, which belong to the same domain as the port in use, the port selection unit allowing the failover port to take over IP address information and iSCSI target information of the port in use so that the failover port maintains the iSCSI session to the host.

16. The storage system according to claim 15, wherein
the management server comprises:
a load information collecting unit for collecting load information on number of iSCSI sessions or on I/O rate for each of the storage ports; and
when selecting the failover port, the port selection unit inquiring the load information on the number of the iSCSI sessions or on the I/O rate for each of the storage ports and selecting for the port in use the failover port out of the storage ports except for the port in use, which have less iSCSI sessions or less I/O rate and which belong to the same broadcast domain as the port in use.

17. A storage system comprising:
a host having an iSCSI initiator function;
a storage having an iSCSI target function and plural storage ports, the storage communicable with the host through an IP network; and
a management server communicable with the storage;
the management server comprising:
a load information collecting unit for collecting load information on number of iSCSI sessions or on I/O rate for each of the storage ports;
a network topology information collecting unit for collecting network topology information on subnet topology and on port topology of the storage system;
an error information collecting unit for collecting form MIB (Management Information Base) error information of packet transmission/receipt on the port in use on which an iSCSI session is being established to the host; and
the selection unit for selecting a failover port when the error information of packet transmission/receipt on the port in use exceeds a predetermined value, the selection unit inquiring the network topology information on the subnet topology and on the port topology of the storage system and the error information of packet transmission/receipt on the port in use and selecting for the port in use the failover port out of the storage ports except for the port in use, which belong to the same domain as the port in use and which have less number of the iSCSI sessions or less I/O rate, the port selection unit allowing the failover port to take over IP address information and iSCSI target information of the port in use so that the failover port maintains the iSCSI session to the host.

18. A storage system comprising:
a host having a NAS client function;
a storage having a NAS server function and plural storage ports, the storage communicable with the host through an IP network; and
a management server communicable with the storage;
the management server comprising:
a load information collecting unit for collecting load information on number of NAS sessions or on I/O rate for each of the storage ports; and
a port selection means for selecting a failover port when a communication failure occurs on one port of the storage ports which is in use to communicate with the host, the selection unit inquiring the load information on the number of the NAS sessions or on the I/O rate for each of the storage ports and selecting for the port in use the failover port out of the storage ports except for the port in use, which have less number of the NAS sessions or less I/O rate, the port selection unit allowing the failover port to take over IP address information of the port in use so that the failover port maintains the iSCSI session to the host.

19. The storage system according to claim 18, wherein
the host has an NFS client function or a CIFS client function, and wherein
the storage is communicable with the host based on NFS protocols or CIFS protocols.

20. A storage system comprising:
a host having a NAS client function;
a storage having a NAS server function and plural storage ports, the storage communicable with the host through an IP network; and
a management server communicable with the storage; the management server comprising:
a network topology information collecting unit for collecting network topology information on subnet topology and on port topology of the storage system; and
a port selection unit for selecting a failover port when a communication error occurs on one port of the storage ports which is in use to communicate with the host, the selection unit inquiring the network topology information on the subnet topology and on the port topology of the storage system and selecting the failover port out of the storage ports except for the port in use, which belong to the same domain as the port in use, the port selection unit allowing the failover port to take over IP address information of the port in use so that the failover port maintains the communication to the host.

21. The storage system according to claim 20, wherein
the host has an NFS client function or a CIFS client function, and wherein
the storage is communicable with the host based on NFS protocols or CIFS protocols.

22. A storage system comprising:
a host having a NAS client function;
a storage having a NAS server function and plural storage ports, the storage communicable with the host through an IP network; and
a management server communicable with the storage; the management server comprising:
a load information collecting unit for collecting load information on number of NAS sessions or on I/O rate for each of the storage ports;
a network topology information collecting unit for collecting network topology information on subnet topology and on port topology of the storage system; and
a port selection unit for selecting a failover port when a communication error occurs on one port of the storage ports which is in use to communicate with the host, the selection unit inquiring the load information on the number of the NAS sessions or on the I/O rate for each of the storage ports and the network topology information on the subnet topology and on the port topology of the storage system and selecting for the port in use the failover port out of the storage ports except for the port in use, which belong to the same domain as the port in use and which have less number of the NAS sessions or less I/O rate, the port selection unit allowing the failover port to takeover IP address information of the port in use so that the failover port maintains the communication to the host.

23. The storage system according to claim 22, wherein
the host has an NFS client function or a CIFS client function, and wherein
the storage is communicable with the host based on NFS protocols or CIFS protocols.

24. A storage device having an iSCSI target function and plural storage ports, and communicable with a host having an iSCSI initiator function; the storage device comprising:
a communication failure detection unit for detecting a communication failure on one port of the storage ports which is in use to communicate with the host;
a port selection unit for selecting a failover port when the communication error occurs on the port in use, the selection unit selecting the failover port out of the storage ports which belong to the same domain as the port in use, the selection unit allowing the failover port to take over IP address information and iSCSI target information of the port in use; and
an iSCSI session retaining unit for retaining the iSCSI session to the host by sending a Gratuitous ARP packet through the failover port.

25. The storage device according to claim 24, wherein
the storage device comprising plural network controllers having plural ports; and
the port selection means for selecting the failover port out of the storage ports which belong to the same broadcast domain as the port in use and which is loaded on a different network controller from the network controller on which the port in use is loaded.

26. A storage device having a NAS server function and plural storage ports, and communicable with a host having a NAS client function; the storage device comprising:
a communication failure detection unit for detecting a communication failure on one port of the storage ports which is in use to communicate with the host;
a port selection unit for selecting a failover port when the communication error occurs on the port in use, the selection unit selecting for the port in use the failover port out of the storage ports, which belong to the same domain as the port in use, the selection unit allowing the failover port to take over IP address information of the port in use; and
a NAS session retaining unit for retaining the NAS session to the host by sending a Gratuitous ARP packet through the failover port.

27. The storage device according to claim 26, wherein
the storage device comprising plural network controllers having plural ports; and
the port selection means for selecting the failover port out of the storage ports which belong to the same broadcast domain as the port in use and which is loaded on a different network controller from the network controller on which the port in use is loaded.

28. A storage device having an iSCSI target function and plural storage ports, and communicable with a host having an iSCSI initiator function; the storage device comprising:
a communication failure detection unit for detecting a communication failure on one port of the storage ports which is in use to communicate with the host;
a port selection unit for selecting a failover port when the communication failure occurs on the port in use, the selection unit selecting the failover port out of the storage ports which belong to the same domain as the port in use and which have less iSCSI sessions or less I/O rate, the selection unit allowing the failover port to take over communication conditions of the port in use; and
an iSCSI session retaining unit for retaining the iSCSI session to the host by sending a Gratuitous ARP packet through the failover port.

29. The storage device according to claim 28, wherein
the storage device comprising plural network controllers having plural ports; and
the port selection means for selecting the failover port out of the storage ports which belong to the same broadcast domain as the port in use and which is loaded on a different network controller from the network controller on which the port in use is loaded.

30. A storage device having a NAS server function and plural storage ports, and communicable with a host having a NAS client function; the storage device comprising:
a communication failure detection unit for detecting an IP communication failure on one port of the storage ports which is in use to communicate with the host;
a port selection unit for selecting a failover port when the IP communication failure occurs on the port in use, the selection unit selecting the failover port out of the storage ports which belong to the same domain as the port in use and which have less NAS sessions or less I/O rate, the selection unit allowing the failover port to take over communication conditions of the port in use; and
an iSCSI session retaining unit for retaining the NAS session to the host by sending a Gratuitous ARP packet through the failover port.

31. The storage device according to claim 30, wherein
the storage device comprising plural network controllers having plural ports; and
the port selection means for selecting the failover port out of the storage ports which belong to the same broadcast domain as the port in use and which is loaded on a different network controller from the network controller on which the port in use is loaded.
